(19) United States
(12) Patent Application Publication
(10) Pub. No.: US 2015/0332001 A1
(43) Pub. Date: Nov. 19, 2015

(54) ROUNDING CHARGE CAPTURE MODULE-MANAGING PATIENT CARE

(71) Applicant: Envision Healthcare Corporation, Greenwood Village, CO (US)

(72) Inventors: Nathan Goldfein, Tijeras, NM (US); David E. Goldfein, Livingston, TX (US)

(73) Assignee: Envision Healthcare Corporation, Greenwood Village, CO (US)

(21) Appl. No.: 14/810,051

(22) Filed: Jul. 27, 2015

Related U.S. Application Data
(63) Continuation-in-part of application No. 13/968,155, filed on Aug. 15, 2013.
Application No. 13/968,155 is a continuation-in-part of application No. 13/598,558, filed on Aug. 29, 2012, now abandoned.
Application No. 13/598,558 is a continuation of application No. 12/840,078, filed on Jul. 20, 2010, now abandoned.
(60) Provisional application No. 62/029,335, filed on Jul. 25, 2014.
(60) Provisional application No. 61/226,986, filed on Jul. 20, 2009.

(51) Int. Cl. G06F 19/00

(52) U.S. Cl. CPC G06F 19/327; G06F 19/322; G06F 19/328

(57) ABSTRACT

Computer implemented methods and apparatuses of managing patient care in a hospital. Machine readable instructions, when executed, provide a first rounding list to a first hospitalist, provide a second rounding list to a second hospitalist, communicate a status of a first set of multiple patients from the first hospitalist to the second hospitalist, communicate a status of a second set of multiple patients from the second hospitalist to the first hospitalist, capture work efforts of each hospitalist, capture billing information of the hospitalists, and provide the rounding lists to at least one hospital administrator. In some embodiments, patients are tracked, for example, using GPS, and current patient location is reported, for instance, to the hospitalist.

### RELATED PATENT APPLICATIONS

This patent application is a non-provisional patent application of, and claims priority to, U.S. provisional patent application No. 62/029,335, filed on Jul. 25, 2014, titled: ROUNDING CHARGE CAPTURE MODULE—MANAGING PATIENT CARE, and this patent application is also a continuation-in-part of, and claims priority to, U.S. non-provisional patent application Ser. No. 13/968,155, filed on Aug. 15, 2013, titled: MANAGING PATIENT CARE THROUGH AN EMERGENCY ROOM OF A HOSPITAL USING A COMPUTER, which is a continuation-in-part of, and claims priority to, U.S. non-provisional patent application Ser. No. 13/598,558, filed on Aug. 29, 2012, titled: ELECTRONIC PHYSICIAN ORDER SHEET, which is a continuation of U.S. non-provisional patent application Ser. No. 12/840,078, filed on Jul. 20, 2010, also titled: ELECTRONIC PHYSICIAN ORDER SHEET, which claims priority to U.S. provisional patent application No. 61/226,986 filed on Jul. 20, 2009, all of which have at least one inventor in common with the current patent application and the same assignee. The contents of all of these priority patent applications are incorporated herein by reference. If there are any conflicts or inconsistencies between this patent application and the patent applications incorporated by reference, however, this patent application governs herein.

### FIELD OF THE INVENTION

Various embodiments of this invention relate to methods and apparatuses for managing patient care in a hospital. Particular embodiments relate to computer implemented methods and apparatus that include at least one computer that contain machine-readable instructions that, when executed by the computer, perform certain acts. Various embodiments are used by a care provider in a hospital.

### BACKGROUND OF THE INVENTION

Healthcare practitioners, such as physicians, typically examine a patient to form a diagnosis, and then order treatment and/or medication based on the diagnosis. As such, physician's efforts have often centered on writing down the orders for treatment and medication. This can lead to a variety of problems wherein a time-constrained physician unintentionally omits things, writes illegibly, or writes the wrong things. Another problem that arises is that the physician's focus is shifted away from diagnosing health issues. This can result in only one primary issue being diagnosed and other issues being missed or ignored. Systems and methods for streamlining the process of providing proper care are needed. Ideally, the systems and processes will encourage physicians and other healthcare practitioners to focus on diagnosis and patient care. Furthermore, the systems and methods can detect and prevent treatment and medication scenarios that may be harmful to the patient. Room for improvement exists over the prior art in these and other areas that may be apparent to a person of ordinary skill in the art having studied this document.

### SUMMARY OF PARTICULAR EMBODIMENTS OF THE INVENTION

This invention provides, among other things, computer systems, apparatuses, and computer implemented methods for managing patient care, for example, in hospitals. Certain aspects of the embodiments address limitations and flaws in the prior art by providing a rounding charge capture module for use by care providers or healthcare practitioners such as hospitalists, for instance. Various embodiments provide, for example, as an object or benefit, that they partially or fully address or satisfy one or more of the needs, potential areas for benefit, or opportunities for improvement described herein, or known in the art, as examples.

Specific embodiments of the invention provide various computer implemented methods of managing patient care in a hospital. In various embodiments, a method includes machine readable instructions that, when executed, perform certain acts. Such acts can include, for example, using the computer, providing a first rounding list to a first hospitalist at the hospital, providing a second rounding list to a second hospitalist at the hospital, or both. Further, various embodiments include communicating a first status of a first set of multiple patients from the first hospitalist to the second hospitalist, communicating a second status of a second set of multiple patients from the second hospitalist to the first hospitalist, or both. Sill further, a number of embodiments include capturing work efforts of the first hospitalist at the hospital, capturing work efforts of the second hospitalist at the hospital, capturing billing information of the first hospitalist at the hospital, capturing billing information of the second hospitalist at the hospital, or a combination thereof. Even further, various embodiments include providing the first rounding list and the second rounding list to at least one hospital administrator.

Further still, in some embodiments, such a method can include (e.g., using the computer) automatically prepopulating data fields to be completed by the first hospitalist, for instance, using information entered by an emergency room physician, identifying: patients that are ready to be seen, identifying what room each of the patients that are ready to be seen is in, prompting the (e.g., first) hospitalist to select a list of active patients that are on the floor (e.g., waiting for the hospitalist), prompting the hospitalist to start a patient evaluation for a particular patient, inputting from the hospitalist an instruction to start the patient evaluation for the particular patient, advising the hospitalist that the patient evaluation for the particular patient has been started, or a combination thereof.

Moreover, in a number of embodiments, the act of providing the first rounding list to the (e.g., first) hospitalist at the hospital includes prompting the hospitalist to select a subcombination or combination of (e.g., at least nine of): a list of patients that are waiting for callback, a list of patients that are on hold, a list of patients that are waiting to interface, a list of patients that are interfacing, a list of patients that have errors, a list of patients that need rooms, a list of patients that need a bed request, a list of patients that are waiting for transfer to a floor, a list of patients that are waiting for evaluation, a list of patients that are being evaluated, and a list of all active patients. Even further, some embodiments include, for example, using the computer, providing to the hospitalist prior medical records of the particular patient, providing to the hospitalist scanned documents for the particular patient, prompting the hospitalist to agree or disagree with a diagnosis for a particular patient, prompting the hospitalist to agree or disagree with a final disposition of the particular patient, inputting from the hospitalist an instruction to finalize the diagnosis for the particular patient, advising the hospitalist that the diagnosis for the particular patient has been updated, transferring the diagnosis for the particular patient to the (e.g., first) rounding list (e.g., after the act of inputting from the hospitalist the instruction to finalize the diagnosis for the particular patient), or a combination thereof.

Even further still, in some embodiments, the act of capturing billing information of the (e.g., first) hospitalist at the hospital further includes (e.g., using the computer) presenting to the hospitalist a list of billing code numbers, prompting the hospitalist to enter codes for billing purposes for a particular patient, or both, and, in particular embodiments, the hospitalist can click on any of the billing code numbers to select (e.g., and enter) the billing code numbers. Furthermore, some methods include prompting the hospitalist to edit patient information for a particular patient. In certain embodiments, for example, the patient information includes at least four (4) of: expected discharge date, admit type, room number, hospitalist assigned, code status, and allergies.

Additionally, certain embodiments of a method include, for instance, using the computer, prompting the (e.g., first) hospitalist to: discharge a particular patient, place a certain patient on hold, or both. Further, particular embodiments include measuring a duration of care time that the hospitalist spends on a particular patient, recording the duration of care time that the hospitalist spends on the particular patient, or both. Still further, some embodiments include prompting the hospitalist to: enter certain information that is yet to be entered (e.g., by color coding a prompt for the certain information), select whether a particular patient needs cross coverage (e.g., by anther physician), select whether a particular patient is designated for discharge (e.g., am discharge), or a combination thereof, as examples.

In some embodiments, the act of capturing billing information (e.g., of the first hospitalist) at the hospital further includes, for example, using the computer: presenting to the hospitalist a current billing list for multiple patients, prompting the hospitalist to enter billing notes for a particular patient, prompting the hospitalist to add a further patient, prompting the hospitalist to designate a certain patient for billing completion, prompting the hospitalist to designate a specific patient to be added to a batch for billing, or a combination thereof. Some embodiments include prompting the hospitalist, for instance, using a contrasting color, when billing information is missing for a current patient (e.g., in some embodiments, including when billing information is missing for the current patient for a previous day), automatically detecting double billing, alerting the hospitalist using a contrasting color when double billing has been detected, or a combination thereof.

Certain embodiments include prompting the (e.g., first) hospitalist to do a search, for example, for a particular patient, for instance, including prompting the hospitalist to search by first name, last name, medical record number, account number, or a combination thereof. Further, particular embodiments include prompting to select a batch list. In some embodiments, the prompting to select a batch list includes listing different batches, the prompting to select a batch list includes color coding the different batches based on whether the batches are open or closed, or both. Still further, some embodiments include (e.g., using the computer) prompting the first hospitalist to designate a particular patient to be transferred for care to the second hospitalist, prompting the first hospitalist to designate whether the particular patient is expected to stay in the hospital for a period of time that includes two midnights, or both. Even further, certain embodiments include notifying the first hospitalist, the second hospitalist, at least one nurse, at least one pharmacist, or a combination thereof, when the particular patient is transferred for care from the first hospitalist to the second hospitalist. Further still, some embodiments include alerting the second hospitalist of priority tasks identified by the first hospitalist.

Particular embodiments of the invention include, for example, using the computer, providing to the (e.g., first) hospitalist a current location of a particular patient. In some embodiments, for instance, the current location of the particular patient is determined using a sensor coupled to the particular patient, the act of providing to the hospitalist the current location of the particular patient includes providing to the hospitalist a current room number in which the particular patient is located, or both. Moreover, some embodiments include, for example, using the computer, automatically notifying at least one hospital administrator when at least one threshold for escalation has been reached. Furthermore, in a number of embodiments, the prompting of the hospitalist includes displaying to the hospitalist, for example, using the computer, an icon that the hospitalist can click on to make a selection. In some embodiments, for instance, the icon includes text that describes the selection.

Other specific embodiments include various apparatuses for managing patient care in a hospital, for example, each apparatus including at least one computer having machine-readable instructions that, when executed by the computer, perform certain acts, such as prompting a hospitalist. Some embodiments, for example, prompt a hospitalist with: a list of patients that are waiting for hospitalist callback, a list of patients that are on hospitalist hold, a list of patients that are waiting to interface, a list of patients that are interfacing, a list of patients that have errors, a list of patients that need rooms, a list of patients that need a bed request, a list of patients that are waiting for transfer to a floor, a list of patients that are waiting for evaluation, a list of patients that are being evaluated, a list of all active patients, or a combination thereof. Further, some embodiments prompt a hospitalist: to edit patient information for a particular patient (e.g., the patient information including: expected discharge date, admit type, room number, hospitalist assigned, code status, allergies, or a combination thereof), to enter codes for billing purposes for the particular patient (e.g., where the hospitalist can click on any of multiple billing code numbers to select and enter the billing code numbers), using a contrasting color (e.g., when billing information is missing for the particular patient), or a combination thereof. In addition, various other embodiments of the invention are also described herein, and various benefits of certain embodiments may be apparent to a person of ordinary skill in the art.

### BRIEF DESCRIPTION OF THE DRAWINGS

The accompanying figures, in which like reference numerals refer to identical or functionally similar elements throughout the separate views and which are incorporated in and form a part of the specification, further illustrate various examples of embodiments, and, together with the written description, serve to explain the principles of certain embodiments.

FIG. 1 is a block diagram illustrating an example of a system, for example, for entering or selecting diagnoses, entering or selecting treatments, entering or selecting medications, and authorizing selections, in accordance with aspects of certain embodiments;

FIG. 2 is a block diagram illustrating an example of a system, for instance, wherein a provider offers electronic physician's order sheets as a service in accordance with aspects of some embodiments;

FIG. 3 is a block diagram illustrating an example of a system, for instance, that includes an alarm module that detects scenarios that can result in patient harm, in accordance with aspects of some embodiments;

FIG. 4 is a high level flow diagram illustrating a method of (e.g., a physician) using an electronic physicians order sheet in accordance with aspects of particular embodiments;

FIG. 5 is a high level flow diagram illustrating a computer implemented method of managing patient care, for example, through an emergency department of a hospital;

FIG. 6 is a block diagram illustrating an apparatus for managing patient care, for example, through at least one emergency department of at least one hospital; and

FIG. 7 is a high level flow diagram illustrating a computer implemented method of managing patient care, for instance, in a hospital.

These drawings illustrate, among other things, examples of certain aspects of particular embodiments. Other embodiments may differ. Various embodiments may include aspects shown in the drawings, described in the specification, shown or described in other documents that are incorporated by reference, known in the art, or a combination thereof, as examples.

### DETAILED DESCRIPTION OF EXAMPLES OF EMBODIMENTS

This patent application describes, among other things, examples of certain embodiments, and certain aspects thereof. Other embodiments may differ from the particular examples described in detail herein. Various embodiments are or concern apparatuses and methods for managing patient care, for example, in a hospital, for instance, having improvements over the prior art. Different embodiments include rounding charge capture modules, for example. In certain embodiments, at least one computer is used, methods are computer implemented, or both.

It is an aspect of some embodiments that a presentation device, such as a tablet computer, mobile phone, or a smart phone, presents a physician, for example, with input/output fields for diagnosis, treatment, and medication, as examples. It is another aspect of certain embodiments to provide a selection means, such as a touch sensitive display, a touch/signature pad, a mouse, a biometric reader, or another device that the healthcare practitioner or physician can use to make selections, communicate with others, etc. The physician, for example, can also use the selection means or a different device, in some embodiments, to sign or otherwise authenticate medications and treatments orders that are selected, in some embodiments. The signing or authorization step is necessary or desirable, in a number of embodiments, because it transforms the selected medications and selected orders into the ordered medications and the physician's orders that are actually obeyed to thereby treat the patient.

In a number of embodiments, a rounding charge capture module is or includes a software tool, computer program, or mobile app, as examples, used by hospitalists, hospital billing staff, or both, as examples. In various embodiments, the rounding charge capture module operates, in whole or in part, on one or more computers, which may include, for instance, one or more desktop computers, laptop computers, tablet computers, smart phones, mobile phones, mobile devices, servers, or a combination thereof, as examples. In some embodiments, the rounding charge capture module is network or web based, for example, and is accessed via one or more computers (e.g., as described herein), for example, in different embodiments, with or without using a mobile app or software installed on each computer or mobile device. The rounding charge capture module is used, in various embodiments, by hospitalists to maintain their rounding list and to communicate (e.g., with other hospitalists), for example, on the status of various patients. In some embodiments, the rounding charge capture module can also be used to capture the work efforts of the hospitalists. Further, in a number of embodiments, billing staff uses the rounding charge capture module to capture the billing of the hospitalists and transmit that information to the billing department. In some embodiments, the rounding charge capture module can be used by additional hospital staff (e.g., administrators), for example, so they have a live, up to date, round list at any time with which to make decisions, evaluate status and performance, etc.

In certain embodiments, an electronic physician's order sheet (EPOS) provides means for a physician to select or enter diagnoses, to automatically receive suggestions for medications and treatments, or both. The physician can select from amongst the suggestions, in a number of embodiments, select alternate medications and treatments, or input and select different medications or treatments, for example. The EPOS can alert the physician to possible drug interactions, allergic reactions, or other alarming situations, in some embodiments. The physician can then sign the EPOS to formally issue orders for treatment and medications in various embodiments. In certain embodiments, the EPOS can be integrated with billing systems, pharmacy systems, and other systems to help automate the processes of drug delivery, invoicing, and patient care, as examples.

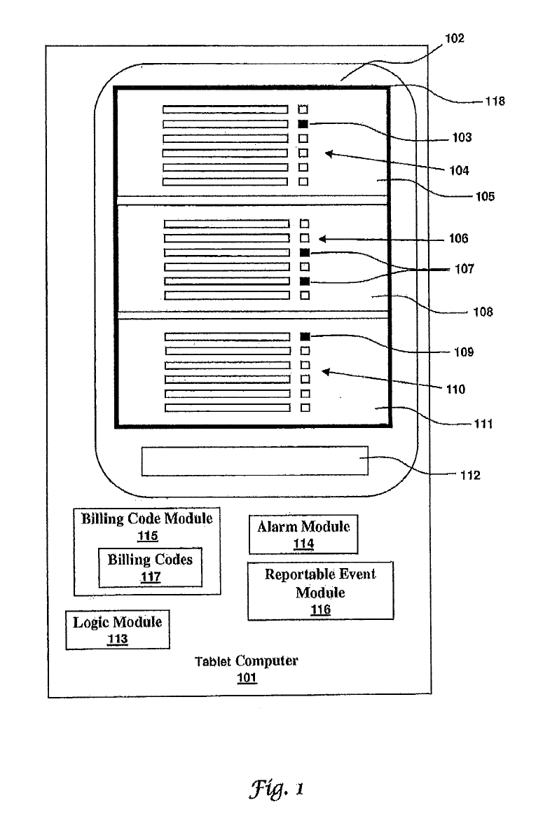

FIG. 1 illustrates an example of a system, for example, for entering or selecting diagnoses, entering or selecting treatments, entering or selecting medications, authorizing selections, or a combination thereof, in accordance with aspects of certain embodiments. A tablet computer 101 can have a presentation device 102, a processor, memory, and input devices, for instance. An input device can be a pen input device, a track pad, a mouse interface, a touch sensitive screen, or other device. The presentation device 102 can be a flat panel display, for example. In the embodiment illustrated, the presentation device 102 can present a graphical user interface (GUI) to a physician, for instance. The GUI can include, in some embodiments, a diagnoses field 105, an order field 108, a medication field 111, and an alert or alarm indicator 118, for example. In the example shown, the alarm indicator is a heavy frame around the other fields, colored red, for instance, which appears when the alarm module 114 has detected an alarm situation. Other embodiments for alarms are sounds or the highlighting of specific elements in the fields to indicate what is causing the alarm, as examples.

In the embodiment depicted in FIG. 1, the diagnoses field 105 can include a number of suggested diagnoses 104. The order field can present a number of possible orders 106 and the medication field can present a number of possible medications. In the example illustrated, the physician has chosen one of the diagnoses as a selected diagnosis 103. The logic module 113 receives the selected diagnosis 103 and suggests two treatments as order suggestions 107 and one of the medications as a medication suggestion 109. In some embodiments, the physician can clear a suggestion, select alternatives, or opt to do nothing in which case the suggestions automatically become the physician's selections. In a number of embodiments, the physician can authenticate or issue the selections by signing on a signature pad 112. In the embodiment shown, the physician's authentication transforms the selections into actual physician's orders for treatments to be performed and into ordered medications to be administered.

In certain embodiments, the reportable events module 116 detects events that must be reported to authorities. Gun shot wounds, certain infectious diseases, and child abuse are examples of reportable events. The reportable events module can alert the physician, in various embodiments, that an event must be reported. In some embodiments, the EPOS can directly and immediately report the event to the proper authorities. In particular embodiments, the billing code module 115 can associate billing codes 117 with the possible orders 106, selected orders 107, possible medications 110, selected medications 109, physician's orders, and medication orders. Many medical treatment facilities currently employ people to attach billing codes to physician's orders and medication orders. The billing code module alleviates the need for such personnel in some embodiments.

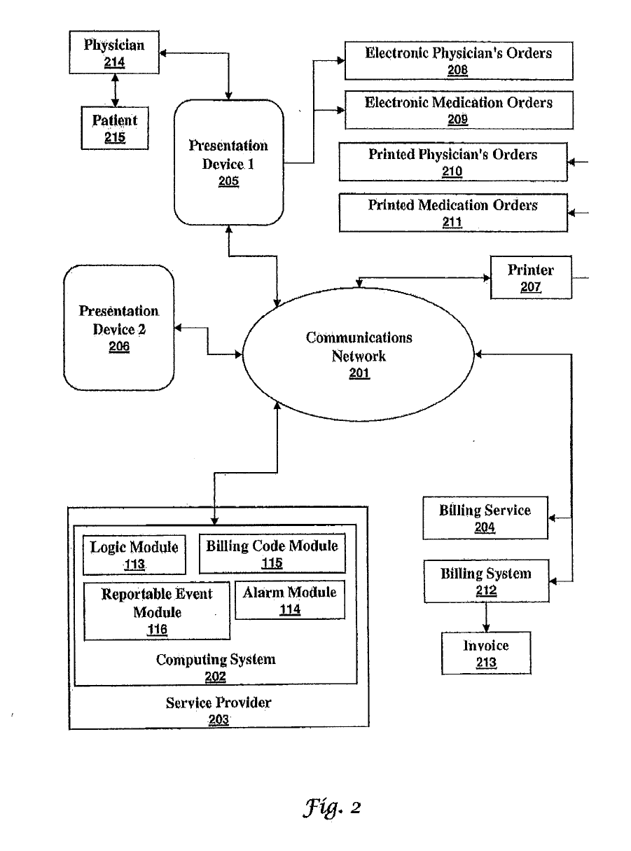

FIG. 2 illustrates an example of a service provider 203 offering electronic physician's order sheets as a service in accordance with aspects of some embodiments. The service provider 203 provides and services a computer or computing system 202 that is connected to a communications network 201 such as the Internet, a phone network, a wireless network, or another communications fabric. The computing system 202 can include the logic module 113, the billing code module 115, the reportable events module 116, and the alarm module 114, as examples. In some embodiments, other systems, services, and devices such as presentation device 1 205, presentation device 2 206, printer 207, billing service 204, and billing system 212 are connected to a communications network and can use it to communicate with each other, with the computing system 202 of the service provider 203, or both.

A physician 214 is shown, for example, using presentation device 1 205 to produce physician's orders and medication orders for the treatment of a patient 215. The orders issued from presentation device 1 205 are initially electronic physician's orders 208 and electronic medication orders 209 in some embodiments. Electronic orders, when properly authenticated, can be obeyed in some health care facilities. The orders can be printed by a printer 207, for example, to produce printed physician's orders 210 and printed medication orders 211. The physician 214 can physically sign the printed orders 210, 211, in some embodiments. In particular embodiments, the orders can (e.g., also) be transmitted to a billing service 204 and/or a billing system 212, for example. A billing system 212 can be, for example, a system that generates and tracks invoices 213 to ensure that a health care provider is compensated for providing care. A billing service 204 can be, in some embodiments, a company under contract to a health care provider to generate invoices and, in certain embodiments, to collect invoice payments.

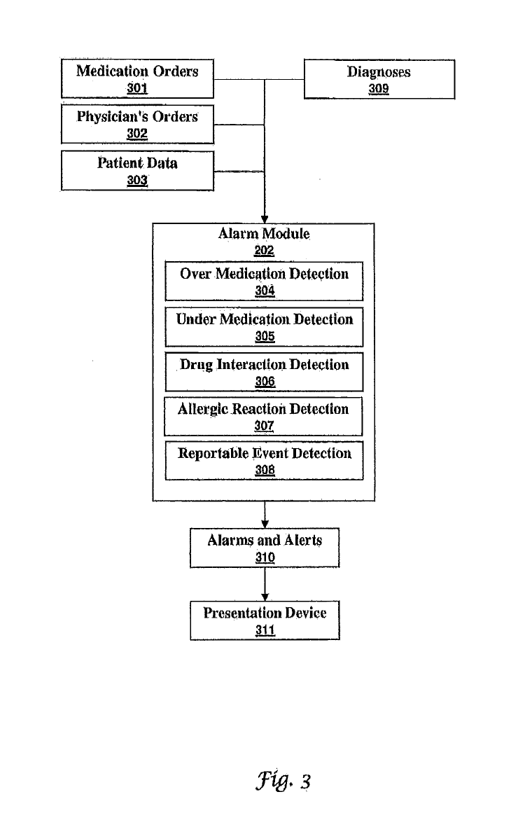

FIG. 3 illustrates an example of an alarm module 202 that detects scenarios that can result in patient harm, in accordance with aspects of some embodiments. Medication orders 301, physician's orders 302, patient data 303, and diagnoses 309 can be input into the alarm module 202, for instance. The patient data 303 can be obtained during the patient intake process, for example, during the course of treatment, or from previously obtained or produced medical records, as examples. The alarm module 202 can detect conditions or scenarios that can harm the patient such as over medication 304, under medication 305, drug interaction 306, and allergic reaction 307, for instance. The alarm module 202 can also function as a reportable event module, in some embodiments, by detecting reportable events 308. Upon detection, the alarm module 202 can produce alarms and/or alerts 310 and submit them to a presentation device 311, for instance. The presentation device 311 can be the very same device that a physician is using to submit diagnoses 309, can be a different device, or can be multiple devices, as examples.

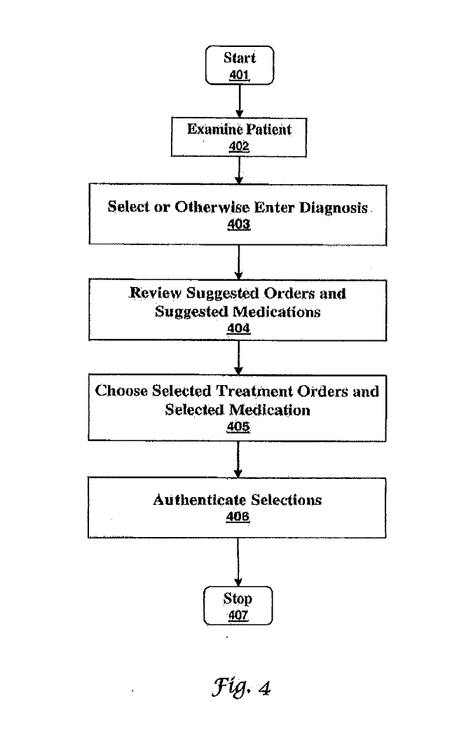

FIG. 4 illustrates an example of a high level flow diagram of a healthcare practitioner, such as a physician (e.g., 214), using an electronic physicians order sheet in accordance with aspects of certain embodiments. After the start 401, the physician examines a patient 402 and selects or otherwise enters diagnoses 403, in this example. The logic module then suggests treatment orders (aka order suggestions) and medication (medication orders) 404. The physician reviews the suggested orders and the suggested medications 404. If the suggestions are not what the physician wants, then other options can be selected (via checkbox, menu, etc.) or otherwise entered into the EPOS, in various embodiments. In a number of embodiments, the desired treatments and medications are selected 405. The physician then authenticates the selections 406, in the embodiment illustrated, so that the appropriate orders are issued to caregivers, such as nurses, and to the pharmacy that provides the medications used to treat the patient, as examples. At this point, in various embodiments, the process stops 407, at least until the physician again examines the patient 402.

A number of embodiments can be implemented in the context of modules. In the computer programming arts, a module can be typically implemented as a collection of routines and data structures that performs particular tasks or implements a particular data type. Modules generally can be composed of two parts in some embodiments. First, a software module may list the constants, data types, variable, routines and the like that that can be accessed by other modules or routines. Second, a software module can be configured as an implementation, which can be private (i.e., accessible perhaps only to the module), and that contains the code that actually implements the routines or subroutines upon which the module is based. Thus, for example, the term module, as utilized herein, generally refers to software modules or implementations thereof. Such modules can be utilized separately or together to form a program product that can be implemented through signal-bearing media, including transmission media and recordable media. Although different modules are described herein, in a number of embodiments, some computer code can be used in different modules, different modules can be combined into the same block of code, certain modules can be made up of different blocks of code, or a combination thereof, as examples.

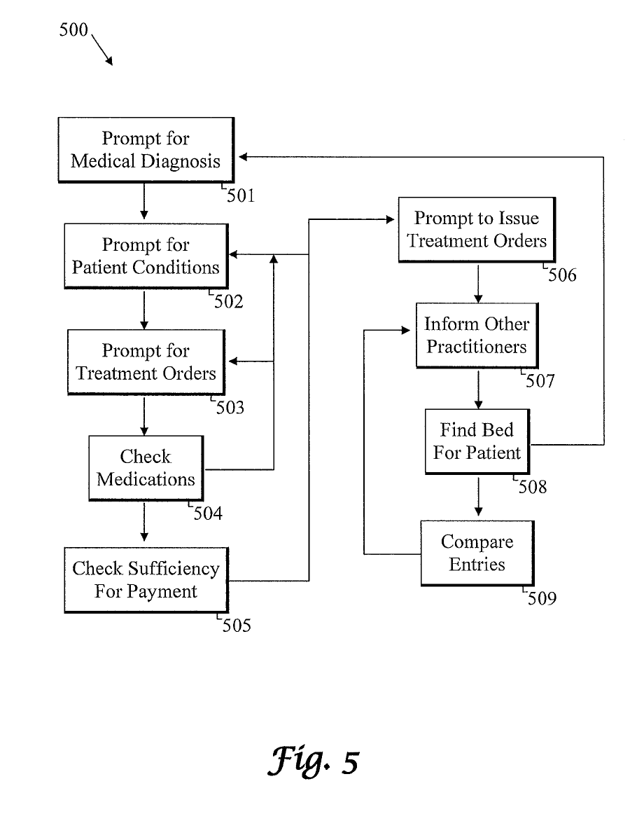

FIG. 5 illustrates an example of a computer implemented method, method 500, of managing patient care, for instance, through an emergency department of a hospital. A patient (e.g., 215 shown in FIG. 2) may enter or be delivered to the emergency department of the hospital, for example, to be seen by an emergency department healthcare practitioner (e.g., physician 214) for a particular condition. In many cases, it may be prudent to admit the patient to the hospital, and the emergency department healthcare practitioner may determine, or be involved in the decision as to, whether to admit the patient to the hospital. In some embodiments, the emergency department healthcare practitioner identifies patients that may be admitted to the hospital. In different embodiments, method 500, or a similar computer-implemented method, can be used for all patients entering the emergency department or just for patients that the emergency department healthcare practitioner identifies for potential admission to the hospital. In a number of embodiments, method 500, or a similar computer-implemented method, can be used to assist with admission criteria. In various embodiments, method 500, or a similar computer-implemented method, can utilize InterQual, InterQual criteria, evidence-based medicine, measurable, clinical indicators, a diagnosis, the level of illness of the patient, the services required, or a combination thereof, as examples.

In some embodiments, the emergency department healthcare practitioner (e.g., 214) may decide to use method 500, or a similar computer-implemented method, for some patients (e.g., 215), but not for others. In certain embodiments, the emergency department healthcare practitioner discusses the patient (e.g., in person or by phone) with an in-patient care practitioner, for instance, concerning whether to use method 500, or a similar computer-implemented method for a particular patient. In some embodiments, if the emergency department healthcare practitioner and the in-patient care practitioner agree that a particular patient is not a candidate for method 500, or a similar computer-implemented method for a particular patient, or if the emergency department healthcare practitioner makes such a decision without consultation with the in-patient care practitioner, the patient may be discharged or transferred to another facility, as examples.

In various embodiments of the example shown, method 500 includes machine-readable instructions that, when executed, perform (e.g., in the order shown in FIG. 5 or in another order), at least certain acts. In the embodiment shown, for example, such acts include, using the computer, act 501 of prompting the emergency department healthcare practitioner (e.g., 214 shown in FIG. 2) to select at least one of several common medical diagnoses for a particular patient. As used herein, the medical diagnosis selected or entered by the emergency department healthcare practitioner is called an ED-identified diagnosis. In certain embodiments, the common medical diagnoses can include, for example, chest pain, pneumonia, congestive heart failure, COPD, Ileus, obstruction, CVA, severe chronic anemia, diverticulitis, pyelonephritis, or a combination thereof. Different embodiments can have a longer or shorter list of common medical diagnoses. Further, in a number of embodiments the healthcare practitioner is given the option to enter another diagnosis besides the common medical diagnoses, if appropriate.

In a number of embodiments, a healthcare practitioner, such as an emergency department healthcare practitioner or an in-patient care practitioner, can be, as examples, a physician (e.g., 214), a physician's assistant, a certified nurse practitioner, or a registered nurse, for instance. In other embodiments, a healthcare practitioner can be, as further examples, an advanced practice registered nurse, a licensed practical nurse, a chiropractor, a dentist, a pharmacist, a clinical pharmacist, a licensed midwife, a certified nurse midwife, a dietitian, a therapist, a psychologist, a clinical officer, a phlebotomist, a physical therapist, a respiratory therapist, an occupational therapist, an audiologist, a speech pathologist, an optometrist, an emergency medical technician, a paramedic, a medical laboratory scientist, a medical prosthetic technician, a radiographer, a social worker, or another professional trained to provide a health care service, as examples.

In the embodiment shown, for each of the several common medical diagnoses prompted in act 501, when selected by the emergency department healthcare practitioner to form the ED-identified diagnosis, method 500 also includes act 502 of prompting the emergency department healthcare practitioner to select or enter multiple patient conditions that are pertinent to the ED-identified diagnosis. As used herein, the multiple patient conditions that are entered or selected by the emergency department healthcare practitioner (e.g., in act 502) can be referred to as ED-observed patient conditions. In various embodiments, the prompting of the emergency department healthcare practitioner to select or enter the multiple patient conditions that are pertinent to the ED-identified diagnosis (e.g., in act 502): reminds the emergency department healthcare practitioner to measure or evaluate the multiple patient conditions that are pertinent to the ED-identified diagnosis for assurance of quality patient care, establishes a record of the ED-observed patient conditions for future reference for care of the patient, and increases probability that sufficient patient conditions are evaluated and recorded to support third-party payment for treatment of the ED-identified diagnosis. Third-party payment can be payment from an insurance company or from a governmental agency or program, as examples. Once prompted in act 502, the practitioner may record observations already made, examine the patient, order tests, enter the patient conditions into the computer, or a combination thereof, for example. Observation of patient conditions, in a number of embodiments, can confirm a diagnosis, rule out a diagnosis (e.g., a main diagnosis or an alternative diagnosis), identify or suggest other diagnoses, narrow a diagnosis, indicate how severe a diagnosed condition is, suggest a specific treatment, or a combination thereof, as examples.

Examples of the multiple patient conditions (e.g., prompted in act 502) that are pertinent to the ED-identified diagnosis include, for example, for a diagnosis of chest pain, patient conditions of: pulse rate, SBP, respiratory rate, history of pain, labs, including biomarkers, hemoglobin, HA1C, TSH, EKG characteristics, age of the patient (e.g., 215), whether the patient is taking aspirin, whether the patient has chronic kidney disease or diabetes, whether the patient is a current or past smoker, whether the patient has a family history of CAD, whether the patient is on any antihypertensive meds, and whether the patient has hyperlipidemia. For some of the multiple patient conditions, the healthcare practitioner (e.g., physician 214) can be prompted (e.g., in act 502) to indicate whether the patient is above or below a threshold (e.g., whether pulse rate is greater than 120, whether SBP is less than 90, whether respiratory rate is greater than 29, or a combination thereof, as examples).

Even further, in some embodiments, the prompting of the emergency department healthcare practitioner (e.g., physician 214 shown in FIG. 2) to select or enter the multiple patient conditions that are pertinent to the ED-identified diagnosis (e.g., act 502) establishes a standard of care for evaluation of the multiple patient conditions in the emergency department for the ED-identified diagnosis. Thus, in a number of embodiments, if the emergency department healthcare practitioner evaluates all of the multiple patient conditions that are identified in act 502, then the emergency department healthcare practitioner will have done what is expected of him in the emergency department for that ED-identified diagnosis. Further, in various embodiments, the emergency department healthcare practitioner entering such patient conditions into the system or apparatus provides evidence that the emergency department healthcare practitioner did what was expected of him in the emergency department for that ED-identified diagnosis. On the other hand, if the emergency department healthcare practitioner does not evaluate all of the multiple patient conditions that are identified in act 502, then, at least in some embodiments, the emergency department healthcare practitioner will not have done what is expected of him in the emergency department for that ED-identified diagnosis, and the record will so indicate. Further, the hospital or other entity in control of the system can control the level of care provided by different healthcare practitioners, can make adjustments when appropriate, and the level of care can be more consistent between different healthcare practitioners.

Further, in the embodiment depicted in FIG. 5, for each of the several common medical diagnoses (e.g., prompted in act 501), when selected by the emergency department healthcare practitioner (e.g., physician 214 shown in FIG. 2) as the ED-identified diagnosis, method 500 further includes act 503 of prompting the emergency department healthcare practitioner to select or enter ED treatment orders, for example, for the ED-identified diagnosis. Moreover, in a number of embodiments, for multiple of the several common medical diagnoses (e.g., prompted in act 501), the prompting (e.g., in act 503) of the emergency department healthcare practitioner to select or enter the ED treatment orders for the ED-identified diagnosis includes: prompting the emergency department healthcare practitioner to select or enter an ED medical prescription, prompting the emergency department healthcare practitioner to select a level of care for the patient (e.g., 215) in the hospital, or both. In various embodiments, a medical prescription can be or include the administration of one or more medications, medical tests, medical treatments, or a combination thereof, as examples. Further, in various embodiments, a level of care for the patient in the hospital can be: admitting the patient to the hospital, observing the patient without admitting the patient to the hospital, or discharging the patient, as examples. In a number of embodiments where the patient is discharged, follow up care can be prescribed, for instance, as part of a medical prescription.

Even further, in the embodiment illustrated, when the ED treatment orders (e.g., prompted for in act 503) for the ED-identified diagnosis (e.g., prompted in act 501 and then selected by the healthcare practitioner) include admitting the patient to the hospital, method 500 also includes act 505 of checking, evaluating, or determining whether sufficient ED-observed patient conditions have been evaluated and recorded to support third-party payment for admitting the patient to the hospital. Further still, in a number of embodiments, including the embodiment shown, if sufficient ED-observed patient conditions have not been evaluated and recorded to support third-party payment for admitting the patient to the hospital, the method (e.g., method 500) includes prompting (e.g., returning to act 502) the emergency department healthcare practitioner (e.g., physician 214 shown in FIG. 2) to either evaluate and enter sufficient ED-observed patient conditions to support third-party payment for admitting the patient to the hospital or, in some embodiments, to enter an explanation of why the patient (e.g., 215) needs to be admitted to the hospital absent the sufficient ED-observed patient conditions to support third-party payment for admitting the patient to the hospital. This encourages the practitioner, in a number of embodiments, to enter sufficient information to obtain payment, while allowing the practitioner the option to admit a patient even if the patient does not appear to qualify for payment based on the information available at that time. As a result, in various embodiments, the practitioner has the final word on whether to admit the patient rather than an automated computer system.

In the embodiment illustrated, method 500 shown in FIG. 5 further includes act 506 of prompting the emergency department healthcare practitioner (e.g., physician 214 shown in FIG. 2) to issue the ED treatment orders for the ED-identified diagnosis. Issuing the orders is essentially equivalent to signing the treatment orders, but in a number of embodiments, can be performed electronically by the practitioner (e.g., by clicking on a “issue treatment orders” button. In some embodiments, the keystroke to issue the orders must be confirmed by the practitioner. Further, in some embodiments, the practitioner must enter a code or password to issue orders. In some embodiments, one or more healthcare practitioners with less education or experience may enter information prompted for in acts 501 to 505, and a healthcare practitioner with a greater amount of education or experience, or with decision-making responsibility, may review the entries, see the patient (e.g., 215), and if appropriate, issue the orders in act 506. In some embodiments, such tasks may be divided in other ways between different healthcare practitioners.

Further, in a number of embodiments, when the ED treatment orders (e.g., prompted in act 503 to be entered) for the ED-identified diagnosis (e.g., prompted in at 501 to be selected) include admitting the patient (e.g., 215) to the hospital, and the emergency department healthcare practitioner (e.g., physician 214 shown in FIG. 2) has issued (e.g., prompted in act 506) the ED treatment orders for the ED-identified diagnosis, the method (e.g., method 500) further includes automatically contacting (e.g., in act 507) the in-patient care practitioner at the hospital, for example, through at least one communications network, and advising the in-patient care practitioner, for instance, of the ED-identified diagnosis and the ED treatment orders. In a number of embodiments, the in-patient care practitioner can be a hospitalist, for example (e.g., another example of physician 214 shown in FIG. 2). In other embodiments, the in-patient care practitioner can be one of the other healthcare practitioners identified herein, as other examples. In different embodiments, this communication (e.g., in act 507) can take the form of an e-mail, a text message, a voice mail, a prerecorded or synthesized voice message (e.g., delivered by phone or page), a posting on a website, or a combination thereof, as examples. Further, in some embodiments, more than one in-patient care practitioner can be so contacted (e.g., in act 507). In certain embodiments, the emergency department healthcare practitioner discusses the patient (e.g., in person or by phone) with the in-patient care practitioner(s), for instance, concerning the decision whether to admit the patient to the hospital, the diagnosis, the treatment orders, the patient conditions, medications, or a combination thereof, as examples. In various embodiments, the emergency department healthcare practitioner can request (e.g., in act 507) that the in-patient care practitioner see the patient in the emergency department, for instance, before the patient is admitted to the hospital or assigned or transported to a bed. In some such embodiments, the in-patient care practitioner may see the patient before releasing the patient to be admitted, assigned a bed, transported to the bed, discharged, or otherwise removed from the emergency department. In particular embodiments, this may involve various acts of method 500 (e.g., prompted to the in-patient care practitioner).

In some embodiments, the emergency department healthcare practitioner makes the decision whether to admit the patient to the hospital. In other embodiments, however, the emergency department healthcare practitioner consults with the in-patient care practitioner on the decision whether to admit the patient to the hospital. In particular embodiments, the emergency department healthcare practitioner identifies patients who may need to be admitted, or for which it may be appropriate to admit the patient, and the in-patient care practitioner makes the final decision whether to admit the patient to the hospital or may approve such a decision, as further examples. In some embodiments, the emergency department healthcare practitioner may consult with, or obtain approval from, (e.g., including informing in act 507) the in-patient care practitioner before treatment orders are issued (e.g., in act 506 or a similar act), as another example. In some embodiments, the emergency department healthcare practitioner presses a button or clicks on an icon to have the computer or apparatus contact the in-patient care practitioner (e.g., in act 507), for instance, which, as used herein, is included within the meaning of “automatically” when referring to act 507. In other embodiments, however, another event or act may trigger act 507 or the contacting of the in-patient care practitioner, such as, for example, issuing the orders (e.g., prompted to be issued in act 506).

Even further, in some embodiments, including in the example of method 500, when the ED treatment orders (e.g., prompted to be entered in act 503) for the ED-identified diagnosis (e.g., prompted to be selected in act 501) include admitting the patient to the hospital, and the emergency department healthcare practitioner has issued (e.g., prompted to be issued in act 506) the ED treatment orders for the ED-identified diagnosis, the method further includes automatically initiating a process, through at least one communications network, to find a bed for the patient at the hospital (e.g., act 508). Such a network can be, for example, a computer network, a local area network, a wide area network, the Internet, or a telephone network (e.g., a mobile phone network), as examples. In particular embodiments, when the ED treatment orders (e.g., prompted to be entered in act 503) for the ED-identified diagnosis (e.g., prompted to be selected in act 501) include admitting the patient to the hospital, and the emergency department healthcare practitioner has issued the ED treatment orders for the ED-identified diagnosis (e.g., prompted to be issued in act 506), the method (e.g., 500) further includes (e.g., using the computer) finding and assigning a bed for the patient (e.g., in act 508) based on at least one of: the ED-identified diagnosis (e.g., prompted to be entered in act 501) or the ED-observed patient conditions (e.g., prompted to be entered in act 502). For instance, the gender, age, level of care required, diagnosis, or a combination thereof, as examples, can be used to determine which bed to select for the patient (e.g., in act 508).

In other embodiments, act 508 can involve the computer (e.g., automatically) contacting one or more people (e.g., hospital staff or administrators or case management) to find a bed for the patient, for instance, by sending an e-mail, a text message, a pre-recorded or synthesized voice phone message, a page, or a voice mail, or by making a posting on a website, as examples, or a combination thereof. In certain embodiments, when the ED treatment orders for the ED-identified diagnosis include admitting the patient to the hospital, and the emergency department healthcare practitioner has issued (e.g., prompted in act 506) the ED treatment orders for the ED-identified diagnosis, method 500 further includes (e.g., in act 508) following up, for instance, at a predetermined time, on the process to find the bed for the patient at the hospital. Such a predetermined time can be, for example, a quarter of an hour, a half hour, three quarters of an hour, an hour, an hour and a half, two hours, three hours, or four hours, as examples, or a combination thereof.

In particular embodiments, act 508 (e.g., of automatically initiating the process to find the bed for the patient at the hospital) includes automatically contacting a hospital administrator to request the bed, and the act (within act 508) of following up at a predetermined time on the process to find the bed for the patient at the hospital includes automatically contacting a superior of the hospital administrator to request the bed, for instance, after the predetermined time. Such a superior can be, for example, a house supervisor. In such embodiments, automatic escalation to the superior can encourage that a bed is found promptly, promote better patient care, and avoid a pile up of patients in the emergency department that are waiting for a bed, as examples. In addition, in some embodiments, such escalation can provide a reliable means of communication up through the chain of command if the hospital is overwhelmed by patients, for example, so appropriate action can be efficiently taken to accommodate the increase in demand.

In some embodiments, once a bed is assigned, the computer or apparatus (e.g., automatically) notifies the transport or ED Unit clerk, the charge nurse, or both (e.g., in act 507). Further, in some embodiments, the computer or apparatus (e.g., automatically) notifies the in-patient care practitioner when the patient arrives at the bed. Even further, in particular embodiments, the emergency department healthcare practitioner, the in-patient care practitioner (e.g., both of which can be examples of physician 214 shown in FIG. 2), a hospital administrator, or a combination thereof, is notified (e.g., automatically) by the computer or apparatus if the patient is not delivered to the bed within a predetermined amount of time. Even further still, in some embodiments, an alert is made (e.g., automatically, for instance, to the in-patient care practitioner, to a hospital administrator, or both) by the computer or apparatus if the in-patient care practitioner does not start to evaluate the patient (e.g., responding to prompts of acts 501-503) or issue treatment orders (e.g., prompted in act 506) within a predetermined time, for example, after the patent (e.g., 215) is delivered to the bed.

In some embodiments, for a plurality of the several common medical diagnoses (e.g., prompted to be selected in act 501), the act of prompting the emergency department healthcare practitioner (e.g., physician 214 shown in FIG. 2) to select or enter an ED medical prescription (e.g., in act 503) includes prompting the emergency department healthcare practitioner to select or enter at least one medical test. Examples of medical tests, that may apply for different medical diagnoses, include blood tests, x-rays, an MRI, or an EKG, for instance. Further, in a number of embodiments, at least for a plurality of the several common medical diagnoses, the act of prompting the emergency department healthcare practitioner to select or enter an ED medical prescription (e.g., in act 503) includes prompting the emergency department healthcare practitioner to select or enter an ED medication prescription. Further still, in some embodiments, method 500 further includes (e.g., within act 503) prompting the emergency department healthcare practitioner to select the ED medication prescription from multiple medication alternatives. In a number of embodiments, the multiple medication alternatives are each commonly prescribed for the ED-identified diagnosis. Even further still, in certain embodiments, the multiple medication alternatives are each hospital-preferred medications for the ED-identified diagnosis. In this way, the hospital (or another entity in control of the list of medication alternatives) can guide practitioners to prescribe medications that the hospital (or other entity) has found to be effective, safe, available, cost effective, or a combination thereof, as examples.

Still further, in some embodiments, such a method (e.g., 500 shown in FIG. 5) can include (e.g., at least one of): suggesting to the emergency department healthcare practitioner (e.g., in act 503) a dosage for the ED medication prescription or for each of the multiple medication alternatives, or prompting the emergency department healthcare practitioner (e.g., physician 214 shown in FIG. 2) to select or enter a dosage for the ED medication prescription, evaluating whether the dosage selected or entered by the emergency department healthcare practitioner for the ED medication prescription is within a recommended dosage range for the ED medication prescription, and alerting if the dosage entered by the emergency department healthcare practitioner for the ED medication prescription is not within the recommended dosage range for the ED medication prescription. In a number of embodiments, the (e.g., emergency department) healthcare practitioner can be alerted (e.g., before act 506), and in some embodiments, other practitioners (e.g., the healthcare practitioner's supervisor, the pharmacist, or the nurse) can be alerted (e.g. in act 507), for example, after the healthcare practitioner has issued the treatment orders (e.g. in act 506).

Further, in some embodiments, the method (e.g., 500 shown in FIG. 5) further includes prompting the emergency department healthcare practitioner (e.g., physician 214 shown in FIG. 2) to select or enter a body weight or mass of the patient (e.g., in act 502), automatically calculating a dosage or a dosage range for the ED medication prescription or for the multiple medication alternatives (e.g., in act 504), for instance, using the body weight of the patient (e.g., 215), and communicating the dosage or the dosage range for the ED medication prescription or for the multiple medication alternatives to the emergency department healthcare practitioner (e.g., in act 503) for use in determining the ED treatment orders for the ED-identified diagnosis.

Even further, in some embodiments, the method (e.g., 500) further includes, using the computer, identifying other medications that the patient (e.g., 215) is taking (e.g., in act 504), automatically checking for risk of negative interactions between the other medications that the patient is taking and the ED medication prescription (e.g., prompted to be entered in act 503) or the multiple medication alternatives (e.g., prompted for selection in act 503), and alerting if the risk of negative interactions between the other medications that the patient is taking and the ED medication prescription or the multiple medication alternatives is considered to be excessive. Again, in a number of embodiments, the (e.g., emergency department) healthcare practitioner can be alerted (e.g., before act 506), and in some embodiments, other practitioners (e.g., the healthcare practitioner's supervisor, the pharmacist, or the nurse) can be alerted (e.g. in act 507), for example, after the healthcare practitioner has issued the treatment orders. In a number of embodiments, the other medications that the patient is taking (e.g., other than those medications prompted to be entered in act 503), can be identified (e.g., in act 504) by checking the patient's electronic medical records, by asking the patient or the patient's family members, from paperwork that the patient has been asked to complete, from pharmacy records for the patient, or from blood tests performed on the patient (e.g., prompted for in act 502 or 503), as examples.

Moreover, in particular embodiments, when the ED treatment orders (e.g., prompted for in act 503) for the ED-identified diagnosis (e.g., prompted for selection in act 501) include admitting the patient (e.g., 215 shown in FIG. 2) to the hospital and administering the ED medication prescription, and the emergency department healthcare practitioner (e.g., physician 214 shown in FIG. 2) has issued the ED treatment orders for the ED-identified diagnosis (e.g., in act 506), the method (e.g., 500 in FIG. 5) further includes automatically communicating the ED medication prescription to a pharmacy for the hospital (e.g., in act 507). Further, in particular embodiments, when the ED treatment orders (e.g., prompted for in act 503) for the ED-identified diagnosis include admitting the patient to the hospital, and the emergency department healthcare practitioner has issued the ED treatment orders for the ED-identified diagnosis (e.g., pursuant to act 506), the act of automatically contacting the in-patient care practitioner at the hospital (e.g., act 507) further includes advising the in-patient care practitioner of the ED-observed patient conditions selected or entered by the emergency department healthcare practitioner (e.g., prompted for entry in act 507).

In a number of embodiments, (e.g., after act 507, after act 508, or both, at least in certain situations (e.g., when the patient is admitted to the hospital) the in-patient care practitioner (e.g., another example of physician 214 shown in FIG. 2) takes over the care of the patient (e.g., 215) and responsibility for the patient from the emergency department healthcare provider. In various embodiments, method 500, portions thereof, or a similar method, may be repeated for, conducted for, or applied to, the in-patient care provider. For example, in certain embodiments, when the ED treatment orders (e.g., prompted to be selected or entered in act 503) for the ED-identified diagnosis (e.g., prompted for selection in act 501) include admitting the patient to the hospital, and the emergency department healthcare practitioner has issued the ED treatment orders for the ED-identified diagnosis (e.g., prompted for issuance in act 506), the method (e.g., 500) further includes: prompting (e.g., in act 501) the in-patient care practitioner (e.g., hospitalist) to select at least one of the several common medical diagnoses, forming an IP-identified diagnosis, and for each of the several common medical diagnoses, when selected by the in-patient care practitioner as the IP-identified diagnosis, prompting (e.g., in act 502) the in-patient care practitioner to select or enter multiple patient conditions that are pertinent to the IP-identified diagnosis. As used herein, the multiple patient conditions that are entered or selected by the in-patient care practitioner are referred to as IP-observed patient conditions.

In a number of such embodiments, the prompting (e.g., in act 502) of the in-patient care practitioner (e.g., physician 214 shown in FIG. 2) to select or enter the multiple patient conditions that are pertinent to the IP-identified diagnosis: reminds the in-patient care practitioner to measure or evaluate the multiple patient conditions that are pertinent to the IP-identified diagnosis for assurance of quality patient care, establishes a record of the IP-observed patient conditions for future reference for care of the patient, and increases probability that sufficient patient conditions are evaluated and recorded to support third-party payment for treatment of the IP-identified diagnosis. Again, once prompted in act 502, the practitioner may record observations already made, examine the patient, order tests, enter the patient conditions into the computer, or a combination thereof, for example.

Even further, in some embodiments, the prompting of the in-patient care practitioner to select or enter the multiple patient conditions that are pertinent to the IP-identified diagnosis (e.g., act 502) establishes a standard of care for evaluation of the multiple patient conditions for the in-patient care practitioner for the IP-identified diagnosis. Thus, if the in-patient care practitioner evaluates all of the multiple patient conditions that are identified in act 502, then the in-patient care practitioner will have done what is expected of him for that IP-identified diagnosis. Further, the in-patient care practitioner entering such patient conditions into the system provides evidence that the in-patient care practitioner did what was expected of him for that IP-identified diagnosis. On the other hand, if the in-patient care practitioner does not evaluate all of the multiple patient conditions that are identified (e.g., in act 502), then the in-patient care practitioner will not have done what was expected of him for that IP-identified diagnosis, and the record will so indicate. Further, the hospital, or other controlling entity, can control the level of care provided by different healthcare practitioners, can make adjustments when appropriate, and the level of care will be more consistent between different healthcare practitioners.

In some embodiments, the standard of care for the in-patient care practitioner, may be the same, or may differ, from the standard of care for the in-patient care provider (e.g., both examples of physician 214 shown in FIG. 2), and the patient conditions that are prompted (e.g., in act 502) may reflect such differences. For example, in some embodiments, the in-patient car practitioner may be expected to do a more thorough examination or may be expected to do more testing and therefore may be prompted for a greater number of patient conditions (e.g., in act 502) for a given diagnosis. Further, in some instances, the medical diagnosis selected by the in patient care practitioner may differ from that selected by the emergency department healthcare practitioner, for example, due do different observations, professional experience, or other factors. Different medical diagnoses (e.g., selected in act 501) may result in different patient conditions being prompted in act 502, and different treatment orders in act 503, among other things.

Further, in many such embodiments, for each of the several common medical diagnoses (e.g., prompted for in act 501), when selected by the in-patient care practitioner as the IP-identified diagnosis, the method (e.g., 500 shown in FIG. 5) further includes prompting the in-patient care practitioner (e.g., in act 503) to select or enter in-patient care practitioner treatment orders for the IP-identified diagnosis. In a number of these embodiments, for multiple of the several common medical diagnoses (e.g., prompted in act 501), the prompting (e.g., in act 503) of the in-patient care practitioner to select or enter the in-patient care practitioner treatment orders for the IP-identified diagnosis includes prompting the in-patient care practitioner to select or enter an in-patient care practitioner medical prescription. Medication dosages, interactions, or both, may be checked (e.g., in act 504), for instance, as described herein for the emergency department.

Even further, some such embodiments further include determining (e.g., in act 505) whether sufficient patient conditions have been evaluated and recorded to support third-party payment for the level of care in the treatment orders (e.g., admitting the patient to the hospital), and if sufficient patient conditions have not been evaluated and recorded to support third-party payment for the level of care, prompting (e.g., in act 503) the in-patient care practitioner to either evaluate and enter sufficient patient conditions to support third-party payment (e.g., for admitting the patient to the hospital) or to enter an explanation of why the patient needed to be admitted to the hospital (or the level of care need to be implemented) absent sufficient patient conditions to support third-party payment for that level of care. In a number of embodiments, such a method (e.g., 500) further includes an act of prompting the in-patient care practitioner to issue the in-patient care practitioner treatment orders for the IP-identified diagnosis (e.g., act 506).

In particular embodiments, such a method (e.g., 500) can further include automatically comparing the IP-identified diagnosis to the ED-identified diagnosis (e.g., in act 509) and alerting (e.g., in that act or in act 507) if the IP-identified diagnosis is sufficiently different than the ED-identified diagnosis. Further, in some embodiments, the method (e.g., 500) can further include acts of: automatically comparing the IP-observed patient conditions to the ED-observed patient conditions (e.g., in act 509, both patient conditions being prompted to be entered in act 502) and alerting (e.g., in that act or in act 507) if the IP-observed patient conditions are sufficiently different than the ED-observed patient conditions. In various embodiments, act 509 can be used as a teaching tool for the emergency department healthcare practitioner, so they will know whether their initial diagnosis was correct, as a performance evaluation tool to evaluate whether the emergency department healthcare practitioner is making accurate diagnoses, or as a way of evaluating whether additional patient conditions should be prompted for (e.g., in act 502) and evaluated to distinguish between different diagnoses that can otherwise be confused, as examples.

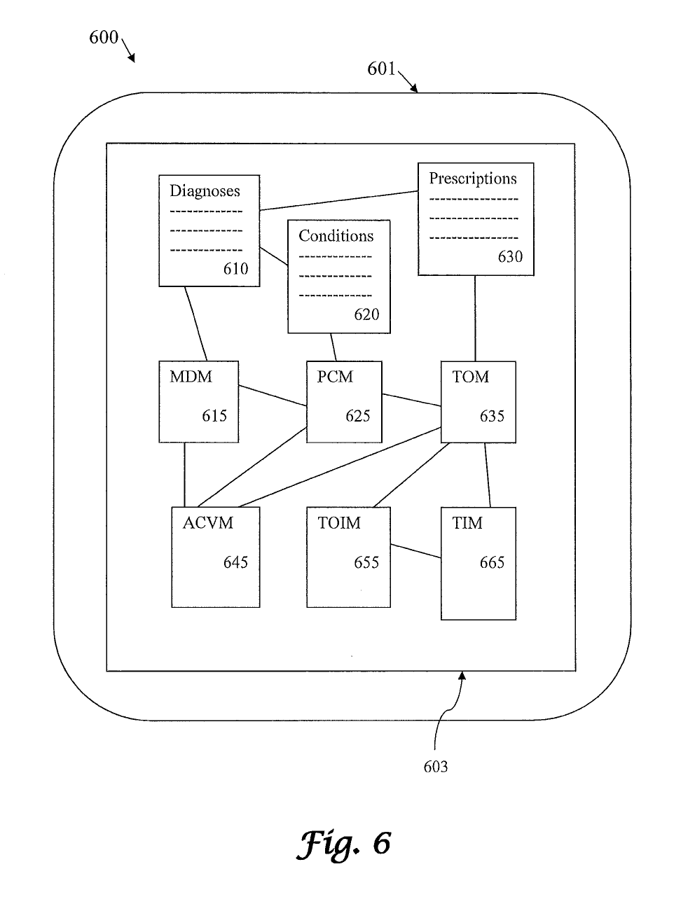

FIG. 6 illustrates an example of an apparatus 600 for managing patient care, for instance, in a hospital or through at least one emergency department of at least one hospital, as examples. In the embodiment illustrated, apparatus 600 includes, for example, computer 601. Various embodiments include at least one computer, for example, 1, 2, 3, 4, or more computers containing various machine-readable instructions. In the embodiment illustrated, computer 601 includes machine-readable instructions 603. Computer 601 can be or include a tablet computer, for example, or can be or include a laptop computer, a desktop computer, a server, a mainframe computer, a smart phone, or a combination thereof (e.g., one or more each of a combination thereof), as examples, and machine-readable instructions 603 can be stored, located, or operating on or through one or more such computers. In various embodiments, computer 601 can include a microprocessor, user interface (e.g., display, screen, keypad, touch screen, etc.), memory, operating system, software, etc., In particular embodiments, for example, machine-readable instructions 603 can be stored on one or more servers and can be accessed by a tablet computer (e.g., 601) via a network, for instance, the Internet.

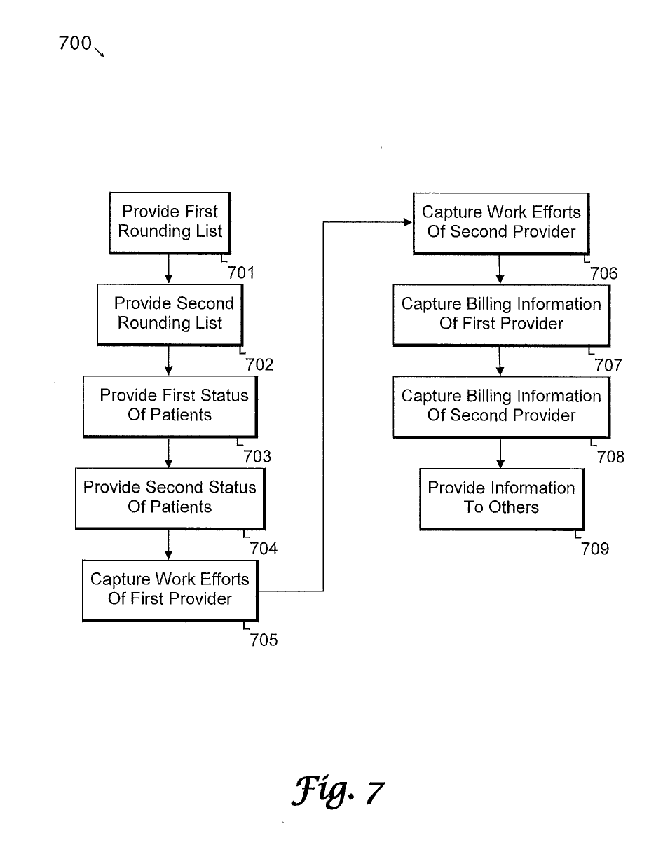

In different embodiments, as examples, the machine-readable instructions (e.g., 603) include some or all of the items or categories shown in FIG. 6, instructions to perform some or all of the acts or categories of acts shown in FIG. 7, or both. In the embodiment shown in FIG. 6, machine-readable instructions 603 include list 610 of several common medical diagnoses for presentation to a healthcare practitioner, such as an emergency department healthcare practitioner (e.g., via computer 601). Further, in the embodiment illustrated in FIG. 6, machine-readable instructions 603 include, for instance, for each of the several common medical diagnoses on list 610, list 620 of multiple pertinent patient conditions for presentation (e.g., to the emergency department healthcare practitioner). Although one list 620 is shown, in a number of embodiments, a different list 620 is maintained for each of the several common medical diagnoses on list 610. In some embodiments, however, some of the several common medical diagnoses on list 610 may have some or all of the same multiple pertinent patient conditions for presentation to the (e.g., emergency department) healthcare practitioner (e.g., items on list 620).

In a number of embodiments, the list 620 of multiple pertinent patient conditions for presentation to the (e.g., emergency department) healthcare practitioner, for example, for each of the several common medical diagnoses on list 610, is selected so that evaluation and documentation of the multiple pertinent patient conditions (e.g., on list 620) for each of the medical diagnoses (e.g., on list 610) can (e.g., if the multiple pertinent patient conditions on list 620 have particular values) support third-party payment for treatment thereof (i.e., treatment of the particular medical diagnosis selected from list 610). Further, in the embodiment shown in FIG. 6, apparatus 600, or machine-readable instructions 603 include, (e.g., for each of the several common medical diagnoses), a list 630 of alternative medication prescriptions, for instance, for each of the several common medical diagnoses (e.g., on list 610) for presentation to the (e.g., emergency department) healthcare practitioner (e.g., physician 214 shown in FIG. 2). Such a presentation can be made, for example, on computer 601. Further, although one list 630 is shown, in a number of embodiments, a different list 630 is maintained for each of the several common medical diagnoses on list 610. In some embodiments, however, some of the several common medical diagnoses on list 610 may have some or all of the same alternative medication prescriptions for presentation to the (e.g., emergency department) healthcare practitioner (e.g., medications on list 630).

Further, in the embodiment shown in FIG. 6, apparatus 600 or machine-readable instructions 603 include medical diagnosis module 615 that presents list 610 of several common medical diagnoses to the (e.g., emergency department) healthcare practitioner (e.g., physician 214 shown in FIG. 2) and that inputs from the (e.g., emergency department) healthcare practitioner an (e.g., ED-identified) diagnosis (e.g., via computer 601). Even further, in this particular embodiment, apparatus 600 or machine-readable instructions 603 include patient conditions module 625 that presents (e.g., via computer 601) the list 620 of multiple pertinent patient conditions to the (e.g., emergency department) healthcare practitioner for the (e.g., ED-identified) diagnosis after the (e.g., emergency department) healthcare practitioner has selected or input the (e.g., ED-identified) diagnosis into medical diagnosis module 615. In various embodiments, the patient conditions module (e.g., 625) inputs from the (e.g., emergency department) healthcare practitioner the multiple pertinent patient conditions for the (e.g., ED-identified) diagnosis (e.g., input via module 615). Further still, in the embodiment shown in FIG. 6, apparatus 600 or machine-readable instructions 603 include (e.g., ED) treatment order module 635 that presents list of alternative medication prescriptions 630 to the (e.g., emergency department) healthcare practitioner for the (e.g., ED-identified) diagnosis (e.g., presented and input via module 615) after the (e.g., emergency department) healthcare practitioner has input (e.g., via module 615) the (e.g., ED-identified) diagnosis (e.g., from list 610) into medical diagnosis module 615.

In various embodiments, (e.g., ED) treatment order module 635 prompts the (e.g., emergency department) healthcare practitioner for selection between the alternative medication prescriptions (e.g., in list 630), (e.g., ED) treatment order module 635 inputs from the (e.g., emergency department) healthcare practitioner (e.g., ED) treatment orders for the (e.g., ED) identified diagnosis, or both. Further, in a number of embodiments, the (e.g., ED) treatment orders include an (e.g., ED) medication order, for example, indicating whether or not to administer a selection from list 630 of alternative medication prescriptions. Even further, in certain embodiments, (e.g., ED) treatment order module 635 suggests to the (e.g., emergency department) healthcare practitioner a dosage for the (e.g., ED) medication order or for each of the alternative medication prescriptions (e.g., on list 630) for use in the (e.g., ED) treatment orders for the ED-identified diagnosis. Further still, in a number of embodiments, the (e.g., ED) treatment orders input from the (e.g., emergency department) healthcare practitioner through the (e.g., ED) treatment order module 635 include an admission order indicating whether or not to admit the patient (e.g., 215 shown in FIG. 2) to the hospital for the (e.g., ED) identified diagnosis. Some embodiments can include both a medication order and an admission order in the treatment order.

Moreover, in the embodiment shown in FIG. 6, apparatus 600 or machine-readable instructions 603 include admissions criteria verification module 645 which, when the (e.g., ED) treatment orders for the (e.g., ED) identified diagnosis include admitting the patient to the hospital, evaluates whether sufficient (e.g., ED) observed patient conditions (e.g., from list 620) have been evaluated and recorded (e.g., via module 625) to support third-party payment for admitting the patient to the hospital. In certain embodiments, if sufficient (e.g., ED) observed patient conditions have not been evaluated and recorded to support third-party payment for admitting the patient to the hospital, admissions criteria verification module 645 prompts the (e.g., emergency department) healthcare practitioner (e.g., physician 214 shown in FIG. 2) to evaluate and enter sufficient ED-observed patient conditions to support third-party payment for admitting the patient to the hospital. In particular embodiments, admissions criteria verification module 645 gives the healthcare practitioner the alternative option to enter an explanation of why the patient needs to be admitted to the hospital absent sufficient (e.g., ED) observed patient conditions to support third-party payment for admitting the patient to the hospital.

Even further, in the embodiment illustrated in FIG. 6, apparatus 600 or machine-readable instructions 603 include (e.g., ED) treatment order issuance module 655 that provides for the (e.g., emergency department) healthcare practitioner (e.g., physician 214 shown in FIG. 2) to issue the (e.g., ED) treatment orders for the (e.g., ED) identified diagnosis. In various embodiments, the healthcare practitioner can issue the treatment orders by electronically signing them, by clicking on an “issue treatment orders” button or icon, or the like. In some embodiments, module 655 prompts the healthcare practitioner to verify (e.g., by clicking on a button or icon) that he or she wishes to issue the treatment orders. Further, in some embodiments, module 655 requires entering of a password, user identification, or code to issue the treatment orders. In some embodiments, issuance of treatment orders requires authorization by a superior healthcare practitioner, as another example.

Further still, in the embodiment shown in FIG. 6, apparatus 600 or machine-readable instructions 603 include (e.g., ED) treatment implementation module 665. In a number of embodiments, when the (e.g., ED) treatment orders for the (e.g., ED) identified diagnosis include admitting the patient (e.g., 215 shown in FIG. 2) to the hospital, and the emergency department healthcare practitioner has issued the (e.g., ED) treatment orders for the (e.g., ED) identified diagnosis through (e.g., ED) treatment order issuance module 655, treatment implementation module 665 automatically contacts another healthcare practitioner, such as an in-patient care practitioner, for example, at the hospital, for instance, through at least one communications network. In various embodiments, treatment implementation module 665, advises the (e.g., in-patient care practitioner) of the (e.g., ED) identified diagnosis, the (e.g., ED) treatment orders, or both. Even further still, in some embodiments, (e.g., ED) treatment implementation module 665 automatically initiates a process to find a bed for the patient, for example, at the hospital.

In particular embodiments, when the (e.g., ED) treatment orders (e.g., selected or entered via module 635) for the (e.g., ED) identified diagnosis include admitting the patient to the hospital, and the (e.g., emergency department) healthcare practitioner (e.g., physician 214 shown in FIG. 2) has issued the (e.g., ED) treatment orders for the (e.g., ED) identified diagnosis through (e.g., ED) treatment order issuance module 655, (e.g., ED) treatment implementation module 665 also follows up (e.g., at a predetermined time) on the process to find the bed for the patient at the hospital. Examples of such following up on the process of finding a bed are described herein.

In some embodiments, an in-patient care practitioner (e.g., another example of physician 214 shown in FIG. 2) can use apparatus 600, or a similar or identical apparatus, in addition to or rather than an emergency department healthcare practitioner. In certain embodiments, the apparatus can be customized for the in-patient care practitioner or for the emergency department healthcare practitioner, or both, for example, with one or more different (e.g., partially different) lists 610, 620, 630, or a combination thereof. Some embodiments have analogous elements, lists, modules, or a combination thereof, to those shown in FIG. 6, for example. In particular embodiments, the apparatus may be configured so that the in-patient care practitioner can select or input an IP-identified diagnosis, IP-observed patient conditions, and IP treatment orders (e.g., IP medication orders), for example. Further, in some embodiments, the lists, modules, or both, shown in FIG. 6, can be combined or can be divided into more or different lists, modules, or both. Further still, in some embodiments, other modules, lists, or both, such as those described herein, can be combined with part or all of apparatus 600. Further, various modules and other elements described for apparatus can have some or all features described herein for other modules or elements.

In some embodiments, machine-readable instructions 603 can be stored remotely from computer 601, and computer 601 can access machine-readable instructions 603 via a network such as the Internet. In some embodiments, machine-readable instructions 603, or similar versions thereof, can be used by different healthcare practitioners (e.g., physicians 214 shown in FIG. 2), for example, in different hospitals. Further, in some embodiments, machine-readable instructions 603 can be provided to one or more hospitals as a service, for example, in exchange for a monthly fee, or can be provided as a service, for instance, in conjunction with providing one or more healthcare practitioners (e.g., emergency department physicians or hospitalists). In other embodiments, however machine-readable instructions 603 can be owned by, licensed to, or controlled by, (or a combination thereof) the hospital, for example, in competition with other hospitals. Still further, in some embodiments, machine-readable instructions 603 can be provided or controlled by a governmental entity, for example, as a means to assure that all healthcare providers meet a minimum standard of care, as a means to control costs, or both. Even further still, in some embodiments, machine-readable instructions 603 can be provided or controlled by an insurance company, as another example.

Various embodiments include computer implemented methods of managing patient care in a hospital. As used herein, a “hospital” can be a hospital, a medical clinic, a doctor's office, or another type of medical or healthcare facility, as examples. FIG. 7 illustrates, as an example, computer implemented method 700 of managing patient care in a hospital. Method 700 can be implemented on a computer, such as described herein (e.g., 101, 202, or 601). In a number of embodiments, method 700 includes machine readable instructions (e.g., 603 shown in FIG. 6) that, when executed, perform (e.g., in any order, unless stated otherwise or otherwise required), at least certain acts. In method 700, as shown, such acts include, for example, using the computer, act 701 of providing a first rounding list to a first hospitalist at the hospital. As used herein, a hospitalist is a care provider or a healthcare provider, such as a physician (e.g., 214 shown in FIG. 2), whose primary professional focus is the general medical care of patients (e.g., 215 shown in FIG. 2) at the hospital. Another act, in the example of method 700, is act 702 of (e.g., using the computer) providing a second rounding list to a second hospitalist at the hospital. In some embodiments, for example, a rounding list (e.g., provided in act 701, 702, or both, can include, without limitation, some or all of medication orders 301, physician's orders 302, patient data 303, and diagnoses 309, all shown in FIG. 3.

Further, other acts of method 700, in the embodiment illustrated, include, for example, using the computer, act 703 of providing a first status of patients. In a number of embodiments, act 703 can include, for example, communicating a first status of a first set of multiple patients (e.g., 215) from the first hospitalist to the second hospitalist, (e.g., using the computer). Method 700 also include act 704 of providing a second status of patients. In some embodiments, act 704 can include, for instance, communicating a second status of a second set of multiple patients from the second hospitalist to the first hospitalist. Further still, other acts of method 700 include, for instance, using the computer, act 705 of capturing work efforts of a first provider (e.g., health care provider), for instance, the first hospitalist at the hospital, and act 706 of capturing work efforts of a second provider, for example, capturing work efforts of the second hospitalist at the hospital. Even further, in the embodiment illustrated in FIG. 7, method 700 includes (e.g., using the computer) act 707 of capturing billing information of the first provider (e.g., hospitalist at the hospital), and act 708 of capturing billing information of the second provider (e.g., hospitalist at the hospital). Even further still, in the embodiment depicted, method 700 includes, for example, using the computer, act 709 of providing information to others (e.g., providing the first rounding list and the second rounding list to at least one hospital administrator). In some embodiments, various acts described with reference to method 700 may be combined. Further, in some embodiments, various acts described with reference to method 700 may be broken down into multiple acts, and in particular embodiments, acts described with reference to method 700 are described herein as multiple acts, in more detail, or both.

In some embodiments, for instance, act 701 or the act of providing the first rounding list to the first hospitalist (e.g., physician 214 shown in FIG. 2) at the hospital includes identifying patients (e.g., 215) that are ready to be seen, identifying what room each of the patients is in, or both. In a number of embodiments where the first hospitalist is mentioned herein (e.g., but the second hospitalist is not mentioned), it should be understood that in some embodiments, the second hospitalist can perform the same or a similar roll as the first hospitalist, for example, receiving or being presented with or prompted for the same or similar information, options, etc. In various embodiments, multiple (e.g., any number of) hospitalists may use the rounding charge capture module (e.g., of method 700) and may each be provided the same prompts, information, opportunities to input information, etc. In some embodiments, however, different practitioners or hospitalists, or groups thereof, are provided different prompts, information, opportunities to input information, etc., for instance, depending on their role in the hospital.

Further, in some embodiments, act 701 or the act of providing the first rounding list to the first hospitalist at the hospital includes prompting the first hospitalist to select a list of active patients that are on the floor, for instance, waiting for the (e.g., first) hospitalist. Further still, in some embodiments, act 701 or the act of providing the first rounding list to the first hospitalist at the hospital includes prompting the first hospitalist to select one or more of (e.g., at least nine of): a list of patients that are waiting for hospitalist callback, a list of patients that are on hospitalist hold, a list of patients that are waiting to interface, a list of patients that are interfacing, a list of patients that have errors, a list of patients that need rooms, a list of patients that need a bed request, a list of patients that are waiting for transfer to a floor, a list of patients that are waiting for evaluation, a list of patients that are being evaluated, or a list of all active patients. Some embodiments prompt the hospitalist to select a different number of these lists such as 1, 2, 3, 4, 5, 6, 7, 8, 10, or 11 (i.e., all) of these lists, as other examples. Some embodiments prompt the hospitalist to select from a subset of these lists, while still other embodiments prompt the hospitalist to select from a set of options that includes some or all of these lists plus additional options (e.g., lists). Even further, in various embodiments, some or all of the prompting described herein (e.g., in act 701, 702, or both), for example, of the first hospitalist (e.g., in act 701), includes displaying, for example, to the first hospitalist (e.g., using the computer, for instance, 101, 202, or 601, for example, on presentation device 1 205 shown in FIG. 2 or 311 shown in FIG. 3) an icon that (e.g., the first hospitalist) can click on to make a selection. In some embodiments, for example, the icon includes text that describes the selection.

Still further, in a number of embodiments, the computer implemented method (e.g., 700 shown in FIG. 7) further includes an act of (e.g., using the computer) prompting (e.g., in act 701) the first hospitalist (e.g., physician 214 shown in FIG. 2), for example, to start a patient evaluation for a particular patient (e.g., 215). In various embodiments, where a “particular patient” is stated herein, the hospitalist may be prompted, for example, for multiple different patients at once or at different times, for example, sequentially, or may select the “particular patient” from a list of patients. In various embodiments, the hospitalist may evaluate one patient at a time. Moreover, some embodiments include an act of (e.g., using the computer) of inputting from the first hospitalist (e.g., in act 705) an instruction to start the patient evaluation for the particular patient, an act of (e.g., using the computer) advising the first hospitalist that the patient evaluation for the particular patient has been started (e.g., in act 705), or both. Even further still, in some embodiments, the computer implemented method (e.g., 700) includes an act of (e.g., using the computer) prompting the first hospitalist (e.g., in act 701, 703, or 705) to confirm a diagnosis for a particular patient, prompting the first hospitalist to agree or disagree with a diagnosis for a particular patient, prompting the first hospitalist to agree or disagree with a final disposition of the particular patient, or a combination thereof, as examples. Furthermore, in certain embodiments, the computer implemented method (e.g., 700) includes an act of (e.g., using the computer) presenting the first hospitalist with a form (e.g., in act 701, 703, or 705) that prompts the first hospitalist to agree or disagree (i.e., in the judgment of the hospitalist) with a diagnosis for a particular patient, to agree or disagree with a final disposition of the particular patient, or both.

Further still, in some embodiments, the computer implemented method (e.g., 700) includes an act of (e.g., using computer 601) prompting the first hospitalist (e.g., physician 214 shown in FIG. 2) to finalize a diagnosis (e.g., act 705) for a particular patient (e.g., 215), for instance, inputting from the first hospitalist an instruction to finalize the diagnosis for the particular patient, advising the first hospitalist that the diagnosis for the particular patient has been updated, or a combination thereof. Further, in particular embodiments, the computer implemented method includes an act of (e.g., using the computer) for instance, after the act of inputting from the first hospitalist the instruction to finalize the diagnosis for the particular patient, an act (e.g., within act 703, 705, or 707) of transferring the diagnosis for the particular patient to a rounding list (e.g., stored within the computer, for instance, provided in act 701 or 702, or a combination thereof).

In a number of embodiments, the act (e.g., 707 in FIG. 7) of capturing billing information of the first hospitalist (e.g., physician 214 shown in FIG. 2) at the hospital further includes (e.g., using the computer, for instance, 101, 202, or 601) prompting the first hospitalist to enter codes for billing purposes for a particular patient (e.g., 215). Further, in some embodiments, this includes presenting to the first hospitalist (e.g., in act 707) a list of billing code numbers. Further still, in certain embodiments, where the act of prompting the first hospitalist to enter codes for billing purposes for the particular patient includes presenting to the first hospitalist a list of billing code numbers, the first hospitalist can click on any (e.g., one or more) of the billing code numbers, for example, to select and enter the billing code numbers.

Moreover, in various embodiments, the computer implemented method (e.g., 700) includes an act of (e.g., using the computer) prompting the first hospitalist, for example, to edit patient information for a particular patient (e.g., in act 705 or 707). Further, in some embodiments, the patient information includes expected discharge date, admit type, room number, hospitalist assigned, code status, allergies, or a combination thereof, as examples. In certain embodiments, for instance, the computer implemented method (e.g., 700) includes prompting (e.g., in act 705, 706, or both) to edit patient information for at least a certain number of these items of information. In particular embodiments, for example, this “certain number” is four (4). In other embodiments, however, this “certain number” is 1, 2, 3, 5, or 6, as further examples. In some embodiments, for instance, the patient information includes (e.g., all of) expected discharge date, admit type, room number, hospitalist assigned, code status, and allergies. Various embodiments include other prompts as well.

In some embodiments, the computer implemented method (e.g., 700) includes an act, for instance, using the computer, of prompting the first hospitalist (e.g., physician 214 shown in FIG. 2), for example, to discharge a particular patient (e.g., 215), to place a particular patient on hold, or both (e.g., in act 705, 707, or both). In some embodiments, for example, a hospitalist can discharge a patient for instance, by entering a discharge code (e.g., in act 707 or 708). Further, in some embodiments, entering a discharge code takes the particular patient off of a list (e.g., a rounding list, for instance, provided in act 701, 702, 703, 704, 709, or a combination thereof).

Still further, in particular embodiments, the computer implemented method further includes an act (e.g., using the computer), of measuring, recording, or both (e.g., in act 705, 707, or both), a duration of care time that the first hospitalist spends on a particular patient. In various embodiments, the computer implemented method includes an act of (e.g., using the computer) prompting the first hospitalist, for instance, to enter certain information (e.g., information that is yet to be entered) by color coding a prompt for the certain information (e.g., in act 701, 703, 705, 707, or a combination thereof). In some embodiments, for example, a button (e.g., a soft button or soft key, for example, on a touch screen, for instance, on presentation device 1 205 or 311) used to make a selection is color coded, for example, with a contrasting color.

Further, in some embodiments, the computer implemented method (e.g., 700 in FIG. 7) includes an act of prompting the first hospitalist, for instance, to select whether a particular patient needs cross coverage, for example, by anther physician, or is critically ill (e.g., in act 701, 703, or 705). In certain embodiments, a button is provided that can be pressed (e.g., in act 703, 704, or both) to indicate cross cover priority. Still further, in a number of embodiments, the computer implemented method includes an act of prompting the first hospitalist (e.g., in act 703), for example, to select whether a particular patient is designated for am (i.e., morning) discharge. In some embodiments, for example, a button is provided for selection of am discharge. Even further, in some embodiments, the act (e.g., 707) of capturing billing information (e.g., of the first hospitalist) at the hospital, for instance, further includes (e.g., using the computer) prompting the first hospitalist, for example, to enter billing notes for a particular patient.

In a number of embodiments, the act of capturing billing information (e.g., 707), for instance, of the first hospitalist (e.g., physician 214 shown in FIG. 2) at the hospital, further includes, for example, using the computer (e.g., 101, 202, or 601), presenting to the first hospitalist a current billing list, for instance, for multiple patients (e.g., 215). Further, in some embodiments, the computer implemented method (e.g., 700) further includes an act of prompting the first hospitalist (e.g., using the computer) to add a patient (e.g., in act 705, 707, or both). Further still, in certain embodiments, the computer implemented method includes an act of prompting the first hospitalist (e.g., in act 701, 703, 705, 707, or a combination thereof) to do a search (e.g., using the computer), for instance, for a particular patient. Even further, in particular embodiments, the act of prompting the first hospitalist to do the search, for example, for the particular patient, includes prompting the first hospitalist to search by first name, last name, medical record number, account number, or a combination thereof, as examples. Even further still, in some embodiments, the computer implemented method includes an act (e.g., in act 707) of prompting the first hospitalist, for instance, to designate a particular patient (e.g., one patient at a time) for billing completion.

Moreover, in a number of embodiments, the computer implemented method (e.g., 700) includes an act of prompting the first hospitalist, for example, to designate a particular patient (e.g., one patient at a time) to be added to a batch for billing (e.g., within act 707). In various embodiments, the hospitalist may be prompted to select multiple patients to be added to the batch. Furthermore, in certain embodiments, the computer implemented method includes (e.g., within act 707) an act of prompting to select a batch list. In some embodiments, the act of prompting to select a batch list includes, for instance, listing different batches. In addition, in particular embodiments, the act of prompting to select a batch list includes color coding the different batches, for example, based on whether the batches are open or closed.

In a number of embodiments, the computer implemented method (e.g., 700 in FIG. 7) includes (e.g., using computer 101, 202, or 601) an act (e.g., 703) of prompting the first hospitalist (e.g., physician 214 shown in FIG. 2) to designate a particular patient (e.g., one patient at a time) to be transferred for care to the second hospitalist. Similarly, in some embodiments, the computer implemented method includes (e.g., using the computer) an act (e.g., 704) of prompting the second hospitalist to designate a particular patient (e.g., one patient at a time) to be transferred for care to the first hospitalist. In some embodiments, multiple patients can be transferred at a time. Further, in various embodiments where first and second hospitalists are described herein, there may be more than two hospitalists, and the computer implemented method may treat all hospitalists the same, in some embodiments, or may provide some functions or privileges to some hospitalists and not to others, for example, based on level of authority, experience, expertise, or a combination thereof, as examples. Further still, in some embodiments, the computer implemented method includes an act (e.g., in act 703, 705, or 707) of prompting the (e.g., first) hospitalist (e.g., using the computer) to designate whether a particular patient (e.g., one patient at a time of multiple patients) is expected to stay in the hospital for a period of time that includes two midnights.

In various embodiments, the method (e.g., 700 shown in FIG. 7), apparatus (e.g., 600 shown in FIG. 6), or software (e.g., 603 shown in FIG. 6), for example, provides reminders (e.g., in act 701, 702, 705, 706, 707, 708, or a combination thereof), for instance, to the hospitalist (e.g., physician 214 shown in FIG. 2), of core measures. Further, in a number of embodiments, one or more summary sheets are provided, for example, to the hospitalist. Further still, in some embodiments, when the hospitalist, for instance, hovers the cursor over certain text, an icon, prompt, or button, as examples, additional information is automatically provided in a pop-up window. Even further, in various embodiments, one user of the method, apparatus, or system can emulate another user, for example, and do work on their behalf. For example, in some embodiments, a scribe can enter information regarding a patient (e.g., 215 shown in FIG. 2) on behalf of a physician (e.g., 214). In a number of embodiments, the physician (e.g., hospitalist) can then, or later, review the information, orders, etc., make changes or edits if necessary, and approve the information, orders, etc.

In certain embodiments, the computer implemented method (e.g., 700) includes (e.g., using the computer) an act of providing to the (e.g., first) hospitalist a current location of a particular patient (e.g., in act 701). In some embodiments, this information is provided to the hospitalist when the hospital clicks on a particular icon for the particular patient (e.g., 215), for example (e.g., in act 705 or 707). In other embodiments, this location information is displayed for the patient whenever the hospitalist is viewing a page for that patient. In various embodiments, the current location of the particular patient is determined using a sensor coupled to the particular patient, for example, on a wrist band, name tag, or necklace. Further, in particular embodiments, the current location of the particular patient is determined using a global positioning system or GPS. In certain embodiments, another system or method is used (e.g., in addition to or instead of GPS) to scan, triangulate or identify the patient's location, for example, within or outside the hospital. Further still, in some embodiments, the act (e.g., in act 701, 705, or 707) of providing to the (e.g., first) hospitalist the current location of the particular patient includes providing to the first hospitalist (or other hospital personnel), a current room number in which the particular patient is located, for example, in the hospital. Even further, some embodiments show the patients location on a map or floor plan (e.g., of the hospital). Still further, various embodiments indicate (e.g., using the computer) which floor the patient is on, as another example.

Even further still, in some embodiments, the sensor or GPS is used to calculate and determine how long it takes for the patient (e.g., 215) to reach his or her room in the hospital, for example, from when the patient first enters the hospital or is given the sensor or GPS. Moreover, in some embodiments, the sensor or GPS is used to calculate and determine how long it takes for the patient to be sent for treatment or testing, how long procedures take to be performed, or both, as examples, for example, from when the patient first enters the hospital or is given the sensor or GPS. This information can be recorded (e.g., in the rounding list provided in act 701, 702, 709, or a combination thereof) and used to evaluate the efficiency of the hospital or of different departments within the hospital, for example.

In some embodiments, the locations of patients (e.g., 215 shown in FIG. 2) are tracked when the patient is in part or all of the hospital, on the hospital grounds, in neighboring or affiliated facilities, in a region that includes the hospital, or a combination thereof, as examples. Moreover, in particular embodiments, patients are tracked after they leave the hospital, as another example. In some embodiments, this information is used to determine or confirm, for instance, that the patient has been discharged from the hospital. In some embodiments, tracking the location of patients can be used, for example, to track how much exercise a patient has gotten (e.g., walking the halls of the hospital), whether the patient has gone to physical therapy or for other treatment or procedures; how many times they have gone to the bathroom, whether they get up at night, how long they sleep or remain in bed, etc. In certain embodiments, some or all such functions are automated, for example, are recorded (e.g., in the rounding list provided in act 701, 702, 709, or a combination thereof), or both.

In various embodiments, the computer implemented method (e.g., 700 shown in FIG. 7) further includes (e.g., using computer 101, 202, or 601) an act of automatically prepopulating data fields to be completed by the (e.g., first) hospitalist (e.g., in act 701, 704, 705, 707, 709, or a combination thereof). In a number of embodiments, this prepopulating is accomplished, for example, using information entered by an emergency room healthcare provider, such as a physician (e.g., physician 214 shown in FIG. 2), or by one or more other staff or care providers. In a number of embodiments this can save the hospitalist a considerable amount of time and can also avoid errors and conflicting information, in some embodiments. Further, in a number of embodiments, the computer implemented method further includes (e.g., using the computer) an act or acts of notifying the first hospitalist, the second hospitalist, one or more other hospitalists, at least one nurse, and at least one pharmacist, or a combination thereof, for instance, when a particular patient (e.g., one of many patients, which may all be handled similarly in some embodiments) is transferred for care, for example, from the first hospitalist to the second hospitalist (e.g., in act 701, 702, 703, 709, or a combination thereof). In certain embodiments, transfer of a patient, appropriate notifications, or both, can be accomplished with one click of a mouse. In some embodiments, the name of the doctor is identified and contact information is provided, such as an e-mail address, phone number, or both. Further still, in some embodiments, the computer implemented method further includes (e.g., using the computer) an act (e.g., 703) of alerting, for example, the second hospitalist, of priority tasks identified, for instance, by the first hospitalist. In this manner, important priority tasks can be communicated from one healthcare provider to another. In certain embodiments, particular items of care, time of discharge (e.g., morning discharge), or other actions can be identified as a priority for a particular patient (e.g., 215). In some embodiments, anticipated discharge date, time, or both, is communicated. Further, in some embodiments, particular patients can be identified as a priority for morning discharge.

Additionally, in some embodiments, the computer implemented method (e.g., 700 shown in FIG. 7) includes (e.g., using computer 101, 202, or 601) an act (e.g., part of act 707) of prompting the (e.g., first) hospitalist (e.g., physician 214 shown in FIG. 2) when billing information is missing for a particular patient (e.g., one of many patients). In a number of embodiments, the hospitalist may be prompted for all patients (e.g., 215) that have billing information missing. In certain embodiments, the act of prompting the first hospitalist when billing information is missing for a particular patient includes alerting the first hospitalist using a contrasting color (e.g., red text or buttons or yellow highlighting), for example, in comparison with black or gray lettering or no highlighting when billing information appears to be complete. In particular embodiments, the prompting (e.g., in act 707) the first hospitalist when billing information is missing for a particular patient includes prompting the first hospitalist when billing information is missing for the particular patient for a previous day (e.g., for any point in time, or for any point in time within a certain amount of time). Further, some embodiments include (e.g., using the computer) an act (e.g., within act 707, 708, or both) of automatically detecting double billing and prompting (e.g., the hospitalist, the hospital administrator, or both) when double billing has been detected (e.g., in act 701, 702, 703, 704, 707, 708, 709, or a combination thereof). In some embodiments, for example, the act of prompting when double billing has been detected includes alerting the first hospitalist, for example, using a contrasting color (e.g., orange). In a number of embodiments, automatic analysis is preformed, at least to some extent, to find and identify double billing.

In some embodiments, the computer implemented method (e.g., 700) further includes (e.g., using the computer) an act (e.g., within act 701, 702, 703, 704, 705, 706, 707, 708, 709, or a combination thereof) of attaching scanned documents (e.g., medical records) for a particular patient (e.g., for each of many patients). Moreover, in some embodiments, medical records can be accessed, for example, via a link or multiple links. Further, in a number of embodiments, the computer implemented method further includes (e.g., using the computer) an act of providing to the (e.g., first) hospitalist (e.g., physician 214 shown in FIG. 2) prior medical records of a particular patient (e.g., in act 701). Further still, in some embodiments, the computer implemented method (e.g., 700) includes (e.g., using the computer) an act (e.g., 709) of (e.g., automatically) notifying one or more others, for instance, at least one hospital administrator, when at least one threshold for escalation has been reached. In various embodiments, a threshold for escalation may be reached, for example, if a patient evaluation has not been entered or completed within a particular amount of time (e.g., in act 705 or 706), if patient billing information has not been entered or completed within a particular amount of time (e.g., in act 707 or 708), if a patient has not been assigned to a room within a particular amount of time, etc.

Further, various embodiments include a number of apparatuses, for example, for managing patient (e.g., 215 shown in FIG. 2) care in a hospital. In different embodiments, an apparatus (e.g., 600 shown in FIG. 6) for managing patient care in a hospital includes at least one computer (e.g., tablet computer 101 shown in FIG. 1 for instance, computing system 202 shown in FIG. 2, or computer 601 shown in FIG. 6) that includes machine-readable instructions (e.g., 603 shown in FIG. 6) that, when executed by the computer, perform a method (e.g., 700) described herein. Further still, in some embodiments, an apparatus includes at least one computer that includes machine-readable instructions that, when executed by the computer, prompt a hospitalist (e.g., physician 214 shown in FIG. 2) to enter certain information that is yet to be entered (e.g., in act 701, 702, 705, 706, 707, 708, or a combination thereof). Specifically, in some embodiments, the hospitalist is prompted using color coding for the certain information, for instance, using a contrasting color. Further, in particular embodiments, the apparatus includes at least one computer that includes machine-readable instructions that, when executed by the computer, prompt a hospitalist, for example, to select whether a particular patient needs cross coverage, for instance, by anther physician (e.g., in act 703 or 704).

In some embodiments, the machine-readable instructions (e.g., 603 shown in FIG. 6), when executed by the computer (e.g., 101, 202, or 601), prompt a hospitalist (e.g., in act 701, 702, 705, 706, 707, 708, or a combination thereof shown in FIG. 7) with: a list of patients (e.g., 215) that are waiting for hospitalist callback, a list of patients that are on hospitalist hold, a list of patients that are waiting to interface, a list of patients that are interfacing, a list of patients that have errors, a list of patients that need rooms, a list of patients that need a bed request, a list of patients that are waiting for transfer to a floor, a list of patients that are waiting for evaluation, a list of patients that are being evaluated, a list of all active patients, or a combination thereof. Certain embodiments prompt the hospitalist with 1, 2, 3, 4, 5, 6, 7, 8, 9, 10, or all 11 of these lists, as examples.

In some embodiments of an apparatus for managing patient care in a hospital (e.g., 600), the apparatus includes at least one computer (e.g., 101, 202, or 601) that includes machine-readable instructions (e.g., 603) that, when executed by the computer, prompt a hospitalist (e.g., physician 214 shown in FIG. 2) to enter codes for billing purposes for a particular patient (e.g., act 707, 708, or both). In a number of embodiments, the hospitalist can click on any of the billing code numbers, for example, to select or enter (or both) the billing code numbers (i.e., for the particular patient). In some embodiments, the hospitalist can do this for each of the patients (e.g., 215), for example, one patient at a time.

In particular embodiments, the apparatus (e.g., 600 shown in FIG. 6) includes at least one computer (e.g., 601) that includes machine-readable instructions (e.g., 603) that, when executed by the computer, prompt a hospitalist (e.g., physician 214 shown in FIG. 2) to edit patient information for a particular patient (e.g., act 701, 702, 705, 706, 707, or 708, all shown in FIG. 7, or a combination thereof). In certain embodiments, for example, the patient information includes expected discharge date, admit type, room number, hospitalist assigned, code status, allergies, or a combination thereof. Certain embodiments prompt the hospitalist with 1, 2, 3, 4, 5, or 6 of these items of information, as examples. Further, in some embodiments, an apparatus (e.g., 600) for managing patient care in a hospital includes at least one computer (e.g., 601) that includes machine-readable instructions (e.g., 603) that, when executed by the computer, prompt a hospitalist when billing information is missing for a particular patient (e.g., act 707, 708, or both). In particular embodiments, this prompting is performed using a contrasting color, for example.

It should be appreciated that various of the above-disclosed and other features and functions, or alternatives thereof, may be desirably combined into many other different systems and applications. Also, various alternatives, modifications, variations or improvements therein may be made by those skilled in the art which are also anticipated herein. Various embodiments of the subject matter described herein include various combinations of the acts, structure, components, and features described herein, shown in the drawings, or known in the art. Moreover, certain procedures may include acts such as obtaining or providing various structural components described herein, and obtaining or providing components that perform functions described herein. Furthermore, various embodiments include advertising and selling products that perform functions described herein, that contain structure described herein, or that include instructions to perform functions described herein, as examples. Such products may be obtained or provided through distributors, dealers, or over the Internet, for instance. The subject matter described herein also includes various means for accomplishing the various functions or acts described herein or apparent from the structure and acts described, or where appropriate, as a step for accomplishing that function. Further, as used herein, the word “or”, except where indicated otherwise, does not imply that the alternatives listed are mutually exclusive. Even further, where alternatives are listed herein, it should be understood that in some embodiments, fewer alternatives may be available, or in particular embodiments, just one alternative may be available, as examples.

What is claimed is:

1. A computer implemented method of managing patient care in a hospital, the method comprising machine readable instructions that, when executed, perform, using the computer, in any order, at least the acts of:
providing a first rounding list to a first hospitalist at the hospital;
providing a second rounding list to a second hospitalist at the hospital;
communicating a first status of a first set of multiple patients from the first hospitalist to the second hospitalist;
communicating a second status of a second set of multiple patients from the second hospitalist to the first hospitalist;
capturing work efforts of the first hospitalist at the hospital;
capturing work efforts of the second hospitalist at the hospital;
capturing billing information of the first hospitalist at the hospital;
capturing billing information of the second hospitalist at the hospital; and
providing the first rounding list and the second rounding list to at least one hospital administrator.

2. The computer implemented method of claim 1, the hospital having a floor, the method further comprising, using the computer:
automatically prepopulating data fields to be completed by the first hospitalist using information entered by an emergency room physician;
identifying: patients that are ready to be seen; and what room each of the patients that are ready to be seen is in;
prompting the first hospitalist to select a list of active patients that are on the floor waiting for the first hospitalist;
prompting the first hospitalist to start a patient evaluation for a particular patient;
inputting from the first hospitalist an instruction to start the patient evaluation for the particular patient; and
advising the first hospitalist that the patient evaluation for the particular patient has been started.

3. The computer implemented method of claim 1 wherein the act of providing the first rounding list to the first hospitalist at the hospital comprises prompting the first hospitalist to select at least nine of:
a list of patients that are waiting for callback;
a list of patients that are on hold;
a list of patients that are waiting to interface;
a list of patients that are interfacing;
a list of patients that have errors;
a list of patients that need rooms;
a list of patients that need a bed request;
a list of patients that are waiting for transfer to a floor;
a list of patients that are waiting for evaluation;
a list of patients that are being evaluated; and
a list of all active patients.

4. The computer implemented method of claim 1 further comprising, using the computer:
providing to the first hospitalist prior medical records of the particular patient;
providing to the first hospitalist scanned documents for the particular patient;
prompting the first hospitalist to agree or disagree with a diagnosis for a particular patient;
prompting the first hospitalist to agree or disagree with a final disposition of the particular patient;
inputting from the first hospitalist an instruction to finalize the diagnosis for the particular patient;
advising the first hospitalist that the diagnosis for the particular patient has been updated; and
after the act of inputting from the first hospitalist the instruction to finalize the diagnosis for the particular patient, transferring the diagnosis for the particular patient to the first rounding list.

5. The computer implemented method of claim 1 wherein:
the act of capturing billing information of the first hospitalist at the hospital further comprises, using the computer, presenting to the first hospitalist a list of billing code numbers and prompting the first hospitalist to enter codes for billing purposes for a particular patient; and
the first hospitalist can click on any of the billing code numbers to select and enter the billing code numbers.

6. The computer implemented method of claim 1 further comprising, using the computer, prompting the first hospitalist to edit patient information for a particular patient wherein the patient information comprises at least 4 of: expected discharge date, admit type, room number, hospitalist assigned, code status; and allergies.

7. The computer implemented method of claim 1 further comprising, using the computer, prompting the first hospitalist to:
discharge a particular patient; and
place a certain patient on hold.

8. The computer implemented method of claim 1 further comprising, using the computer: measuring a duration of care time that the first hospitalist spends on a particular patient; and recording the duration of care time that the first hospitalist spends on the particular patient.

9. The computer implemented method of claim 1 further comprising, using the computer, prompting the first hospitalist to:
enter certain information that is yet to be entered by color coding a prompt for the certain information;
select whether a particular patient needs cross coverage by anther physician; and
select whether a particular patient is designated for am discharge.

10. The computer implemented method of claim 1 wherein the act of capturing billing information of the first hospitalist at the hospital further comprises, using the computer:
presenting to the first hospitalist a current billing list for multiple patients;
prompting the first hospitalist to enter billing notes for a particular patient;
prompting the first hospitalist to add a further patient;
prompting the first hospitalist to designate a certain patient for billing completion;
prompting the first hospitalist to designate a specific patient to be added to a batch for billing;
prompting the first hospitalist, using a contrasting color, when billing information is missing for a current patient, including when billing information is missing for the current patient for a previous day; and
automatically detecting double billing and alerting the first hospitalist using a contrasting color when double billing has been detected.

11. The computer implemented method of claim 1 further comprising prompting the first hospitalist to do a search for a particular patient including prompting the first hospitalist to search by first name, last name, medical record number, and account number.

12. The computer implemented method of claim 1 further comprising prompting to select a batch list wherein:
the prompting to select a batch list comprises listing different batches; and
the prompting to select a batch list comprises color coding the different batches based on whether the batches are open or closed.

13. The computer implemented method of claim 1 further comprising, using the computer:
prompting the first hospitalist to designate a particular patient to be transferred for care to the second hospitalist;
prompting the first hospitalist to designate whether the particular patient is expected to stay in the hospital for a period of time that includes two midnights;
notifying the first hospitalist, the second hospitalist, at least one nurse, and at least one pharmacist when the particular patient is transferred for care from the first hospitalist to the second hospitalist; and
alerting the second hospitalist of priority tasks identified by the first hospitalist.

14. The computer implemented method of claim 1 further comprising, using the computer, providing to the first hospitalist a current location of a particular patient wherein:
the current location of the particular patient is determined using a sensor coupled to the particular patient; and
the act of providing to the first hospitalist the current location of the particular patient comprises providing to the first hospitalist a current room number in which the particular patient is located.

15. The computer implemented method of claim 1 further comprising, using the computer, automatically notifying at least one hospital administrator when at least one threshold for escalation has been reached.

16. The computer implemented method of claim 1 wherein:
the prompting of the first hospitalist comprises displaying to the first hospitalist, using the computer, an icon that the first hospitalist can click on to make a selection; and
the icon comprises text that describes the selection.

17. The computer implemented method of claim 1 wherein:
the act of providing the first rounding list to the first hospitalist at the hospital comprises identifying patients that are ready to be seen and identifying what room each of the patients that are ready to be seen is in;
the hospital has a floor and the act of providing the first rounding list to the first hospitalist at the hospital comprises prompting the first hospitalist to select a list of active patients that are on the floor waiting for the hospitalist;
the act of providing the first rounding list to the first hospitalist at the hospital comprises prompting the first hospitalist to select at least nine of:
a list of patients that are waiting for hospitalist callback;
a list of patients that are on hospitalist hold;
a list of patients that are waiting to interface;
a list of patients that are interfacing;
a list of patients that have errors;
a list of patients that need rooms;
a list of patients that need a bed request;
a list of patients that are waiting for transfer to a floor;
a list of patients that are waiting for evaluation;
a list of patients that are being evaluated; and
a list of all active patients;
the act of capturing billing information of the first hospitalist at the hospital further comprises, using the computer, prompting the first hospitalist to enter codes for billing purposes for a particular patient;
the act of prompting the first hospitalist to enter codes for billing purposes for the particular patient comprises presenting to the first hospitalist a list of billing code numbers;
the act of prompting the first hospitalist to enter codes for billing purposes for the particular patient comprises presenting to the first hospitalist a list of billing code numbers wherein the first hospitalist can click on the billing code numbers to select and enter the billing code numbers;
the patient information comprises: expected discharge date, admit type, room number, hospitalist assigned, code status; and allergies;
the act of capturing billing information of the first hospitalist at the hospital further comprises, using the computer, prompting the first hospitalist to enter billing notes for at least one patient;
the act of capturing billing information of the first hospitalist at the hospital further comprises, using the computer, presenting to the first hospitalist a current billing list for multiple patients;
prompting the first hospitalist to do a search for a specific patient including prompting the first hospitalist to search by first name, last name, medical record number, and account number;
a current location of the particular patient is determined using a sensor coupled to the particular patient;
the current location of the particular patient is provided to the first hospitalist including a current room number in which the particular patient is located; and
prompting of the first hospitalist comprises displaying to the first hospitalist, using the computer, an icon that the first hospitalist can click on to make a selection wherein the icon comprises text that describes the selection.

18. The computer implemented method of claim 1 further comprising, using the computer:
prompting the first hospitalist to start a patient evaluation for a particular patient;
inputting from the first hospitalist an instruction to start the patient evaluation for the particular patient;
advising the first hospitalist that the patient evaluation for the particular patient has been started;
prompting the first hospitalist to confirm a diagnosis for the particular patient;
presenting the first hospitalist with a form that prompts the first hospitalist to agree or disagree with a final disposition of the particular patient;
prompting the first hospitalist to finalize a diagnosis for the particular patient;
inputting from the first hospitalist an instruction to finalize the diagnosis for the particular patient;
advising the first hospitalist that the diagnosis for the particular patient has been updated;
prompting the first hospitalist to edit patient information for the particular patient;
prompting the first hospitalist to discharge the particular patient;
prompting the first hospitalist to place the particular patient on hold;
measuring a duration of care time that the first hospitalist spends on the particular patient;
recording the duration of care time that the first hospitalist spends on the particular patient;
prompting the first hospitalist to enter certain information that is yet to be entered by color coding a prompt for the certain information;
prompting the first hospitalist to select whether the particular patient needs cross coverage by anther physician;
prompting the first hospitalist to select whether the particular patient is designated for am discharge;
prompting the first hospitalist to add a further patient;
prompting the first hospitalist to do a search for a specific patient;
prompting the first hospitalist to designate the particular patient for billing completion;
prompting the first hospitalist to designate the particular patient to be added to a batch for billing;
prompting to select a batch list;
color coding different batches based on whether the different batches are open or closed;
prompting the first hospitalist to designate the particular patient to be transferred for care to the second hospitalist;
prompting the first hospitalist to designate whether the particular patient is expected to stay in the hospital for a period of time that includes two midnights;
providing to the first hospitalist a current location of the specific patient;
automatically prepopulating data fields to be completed by the first hospitalist using information entered by an emergency room physician;
notifying the first hospitalist, the second hospitalist, at least one nurse, and at least one pharmacist when the particular patient is transferred for care from the first hospitalist to the second hospitalist.
alerting the second hospitalist of priority tasks identified by the first hospitalist;
prompting the first hospitalist when billing information is missing for the particular patient.
automatically detecting double billing;
prompting the first hospitalist when double billing has been detected;
attaching scanned documents for the particular patient;
providing to the first hospitalist prior medical records of the particular patient; and
automatically notifying at least one hospital administrator when at least one threshold for escalation has been reached.

19. An apparatus for managing patient care in a hospital, the apparatus comprising at least one computer comprising machine-readable instructions that, when executed by the computer, prompt a hospitalist with:
a list of patients that are waiting for hospitalist callback;
a list of patients that are on hospitalist hold;
a list of patients that are waiting to interface;
a list of patients that are interfacing;
a list of patients that have errors;
a list of patients that need rooms;
a list of patients that need a bed request;
a list of patients that are waiting for transfer to a floor;
a list of patients that are waiting for evaluation;
a list of patients that are being evaluated; and
a list of all active patients.

20. An apparatus for managing patient care in a hospital, the apparatus comprising at least one computer comprising machine-readable instructions that, when executed by the computer, prompt a hospitalist:
to edit patient information for a particular patient, the patient information comprising: expected discharge date, admit type, room number, hospitalist assigned, code status; and allergies;
to enter codes for billing purposes for the particular patient, wherein the hospitalist can click on any of multiple billing code numbers to select and enter the billing code numbers; and
using a contrasting color when billing information is missing for the particular patient.
